(19) United States
(12) Patent Application Publication
(10) Pub. No.: US 2006/0168095 A1
(43) Pub. Date: Jul. 27, 2006

(54) Multi-modal information delivery system

(76) Inventors: Dipanshu Sharma, San Diego, CA (US); Sunil Kumar, San Diego, CA (US); Chandra Kholia, San Diego, CA (US)

Correspondence Address: FISH & RICHARDSON, PC, P.O. BOX 1022, MINNEAPOLIS, MN, 55440-1022, US

(21) Appl. No.: 10/349,345

(22) Filed: Jan. 22, 2003

Related U.S. Application Data
(60) Provisional application No. 60/350,923, filed on Jan. 22, 2002.

(51) Int. Cl. G06F 15/16

(52) U.S. Cl. 709/217

(57) ABSTRACT

A system and method for multi-modal information delivery is disclosed herein. The method involves receiving a first user request at a browser module operative in accordance with a first protocol applicable to a first mode of information delivery. The method further includes generating a browsing request in response to the first user request, wherein the browsing request identifies information available within a network. Multi-modal content is then created on the basis of the information identified by the browsing request and provided to the browser module. The multi-modal content is formatted in compliance with the first protocol and incorporates a reference to content formatted in accordance with a second protocol applicable to a second mode of information delivery.

### CROSS-REFERENCE TO RELATED APPLICATIONS

This application claims priority under 35 U.S.C. §119(e) to United States Provisional Application No. 60/350,923, entitled MULTIMODE GATEWAY CONTROLLER FOR INFORMATION RETRIEVAL SYSTEM, and is related to U.S. patent application Ser. No. 10/040,525, entitled INFORMATION RETRIEVAL SYSTEM INCLUDING VOICE BROWSWER AND DATA CONVERSION SERVER and to U.S. patent application Ser. No. 10/336,218, filed Jan. 3, 2003 and entitled DATA CONVERSION SERVER FOR VOICE BROWSING SYSTEM, each of which is incorporated by reference herein in its entirety.

### FIELD OF THE INVENTION

The present invention relates to the field of browsers used for accessing data in distributed computing environments and, in particular, to techniques for accessing and delivering such data in a multi-modal manner.

### BACKGROUND OF THE INVENTION

As is well known, the World Wide Web, or simply “the Web”, is comprised of a large and continuously growing number of accessible Web pages. In the Web environment, clients request Web pages from Web servers using the Hypertext Transfer Protocol (“HTTP”). HTTP is a protocol which provides users access to files including text, graphics, images, and sound using a standard page description language known as the Hypertext Markup Language (“HTML”). HTML provides document formatting allowing the developer to specify links to other servers in the network. A Uniform Resource Locator (URL) defines the path to Web site hosted by a particular Web server.

The pages of Web sites are typically accessed using an HTML-compatible browser (e.g., Netscape Navigator or Internet Explorer) executing on a client machine. The browser specifies a link to a Web server and particular Web page using a URL. When the user of the browser specifies a link via a URL, the client issues a request to a naming service to map a hostname in the URL to a particular network IP address at which the server is located. The naming service returns a list of one or more IP addresses that can respond to the request. Using one of the IP addresses, the browser establishes a connection to a Web server. If the Web server is available, it returns a document or other object formatted according to HTML.

As Web browsers become the primary interface for access to many network and server services, Web applications in the future will need to interact with many different types of client machines including, for example, conventional personal computers and recently developed “thin” clients. Thin clients can range between 60 inch TV screens to handheld mobile devices. This large range of devices creates a need to customize the display of Web page information based upon the characteristics of the graphical user interface (“GUI”) of the client device requesting such information. Using conventional technology would most likely require that different HTML pages or scripts be written in order to handle the GUI and navigation requirements of each client environment.

Client devices differ in their display capabilities, e.g., monochrome, color, different color palettes, resolution, sizes. Such devices also vary with regard to the peripheral devices that may be used to provide input signals or commands (e.g., mouse and keyboard, touch sensor, remote control for a TV set-top box). Furthermore, the browsers executing on such client devices can vary in the languages supported, (e.g., HTML, dynamic HTML, XML, Java, JavaScript). Because of these differences, the experience of browsing the same Web page may differ dramatically depending on the type of client device employed.

The inability to adjust the display of Web pages based upon a client's capabilities and environment causes a number of problems. For example, a Web site may simply be incapable of servicing a particular set of clients, or may make the Web browsing experience confusing or unsatisfactory in some way. Even if the developers of a Web site have made an effort to accommodate a range of client devices, the code for the Web site may need to be duplicated for each client environment. Duplicated code consequently increases the maintenance cost for the Web site. In addition, different URLs are frequently required to be known in order to access the Web pages formatted for specific types of client devices.

In addition to being satisfactorily viewable by only certain types of client devices, content from Web pages has been generally been inaccessible to those users not having a personal computer or other hardware device similarly capable of displaying Web content. Even if a user possesses such a personal computer or other device, the user needs to have access to a connection to the Internet. In addition, those users having poor vision or reading skills are likely to experience difficulties in reading text-based Web pages. For these reasons, efforts have been made to develop Web browsers for facilitating non-visual access to Web pages for users that wish to access Web-based information or services through a telephone. Such non-visual Web browsers, or “voice browsers”, present audio output to a user by converting the text of Web pages to speech and by playing pre-recorded Web audio files from the Web. A voice browser also permits a user to navigate between Web pages by following hypertext links, as well as to choose from a number of pre-defined links, or “bookmarks” to selected Web pages. In addition, certain voice browsers permit users to pause and resume the audio output by the browser.

A particular protocol applicable to voice browsers appears to be gaining acceptance as an industry standard. Specifically, the Voice eXtensible Markup Language (“VoiceXML”) is a markup language developed specifically for voice applications useable over the Web, and is described at http://www.voicexml.org. VoiceXML defines an audio interface through which users may interact with Web content, similar to the manner in which the Hypertext Markup Language (“HTML”) specifies the visual presentation of such content. In this regard VoiceXML includes intrinsic constructs for tasks such as dialogue flow, grammars, call transfers, and embedding audio files.

Unfortunately, the VoiceXML standard generally contemplates that VoiceXML-compliant voice browsers interact exclusively with Web content of the VoiceXML format. This has limited the utility of existing VoiceXML-compliant voice browsers, since a relatively small percentage of Web sites include content formatted in accordance with VoiceXML. In addition to the large number of HTML-based Web sites, Web sites serving content conforming to standards applicable to particular types of user devices are becoming increasingly prevalent. For example, the Wireless Markup Language (“WML”) of the Wireless Application Protocol (“WAP”) (see, e.g., http://www.wapforum.org/) provides a standard for developing content applicable to wireless devices such as mobile telephones, pagers, and personal digital assistants. Some lesser-known standards for Web content include the Handheld Device Markup Language (“HDML”), and the relatively new Japanese standard Compact HTML.

The existence of myriad formats for Web content complicates efforts by corporations and other organizations make Web content accessible to substantially all Web users. That is, the ever increasing number of formats for Web content has rendered it time consuming and expensive to provide Web content in each such format. Accordingly, it would be desirable to provide a technique for enabling existing Web content to be accessed by standardized voice browsers, irrespective of the format of such content. As voice-based communication may not be ideal for conveying lengthy or visually-centric sources of information, it would be further desirable to provide a technique for switching between multiple complementary visual and voice-based modes during the information transfer process.

### SUMMARY OF THE INVENTION

In summary, the present invention is directed to a system and method for network-based multi-modal information delivery. The inventive method involves receiving a first user request at a browser module. The browser module operates in accordance with a first protocol applicable to a first mode of information delivery. The method includes generating a browsing request in response to the first user request, wherein the browsing request identifies information available within the network. Multi-modal content is then created on the basis of the information identified by the browsing request and provided to the browser module. The multi-modal content is formatted in compliance with the first protocol and incorporates a reference to content formatted in accordance with a second protocol applicable to a second mode of information delivery.

In a particular aspect the invention is also directed to a method for browsing a network in which a first user request is received at a voice browser operative in accordance with a voice-based protocol. A browsing request identifying information available within the network is generated in response to the first user request. The method further includes creating multi-modal content on the basis of this information and providing such content to the voice browser. In this respect the multi-modal content is formatted in compliance with the voice-based protocol and incorporates a reference to visual-based content formatted in accordance with a visual-based protocol. In a particular embodiment the method includes receiving a switch instruction associated with the reference and, in response, switching a context of user interaction from voice to visual and retrieving the visual-based content from within the network.

In another aspect the present invention relates to a method for browsing a network in which a first user request is received at a gateway unit operative in accordance with a visual-based protocol. A browsing request identifying information available within the network is generated in response to the first user request. The method further includes creating multi-modal content on the basis of the information and providing such content to the gateway unit. In this regard the multi-modal content is formatted in compliance with the visual-based protocol and incorporates a reference to voice-based content formatted in accordance with a voice-based protocol. In a particular embodiment the method further includes receiving a switch instruction associated with the reference and, in response, switching a context of user interaction from visual to voice and retrieving the voice-based content from within the network.

The present invention is also directed to a system for browsing a network in which a voice browser operates in accordance with a voice-based protocol. The voice browser receives a first user request and generates a first browsing request in response to the first user request. A visual-based gateway, operative in accordance with a visual-based protocol, receives a second user request and generates a second browsing request in response to the first user request. The system further includes a multi-mode gateway controller in communication with the voice browser and the visual-based gateway. A voice-based multi-modal converter within the multi-mode gateway controller functions to generate voice-based multi-modal content in response to the first browsing request. In a specific embodiment the multi-mode gateway controller further includes a visual-based multi-modal converter operative to generate visual-based multi-modal content in response to the second browsing request. The multi-mode gateway controller may further include a switching module operative to switch a context of user interaction from voice to visual, and to invoke the visual-based multi-modal converter in response to a switch instruction received from the voice browser.

In another aspect the present invention relates to a system for browsing a network in which a voice browser operates in accordance with a voice-based protocol. The voice browser receives a first user request and generates a first browsing request in response to the first user request. The system further includes a visual-based gateway which operates in accordance with a visual-based protocol. The visual-based gateway receives a second user request and generates a second browsing request in response to the second user request. The system also contains a multi-mode gateway controller in communication with the voice browser and the visual-based gateway. The multi-mode gateway controller includes a visual-based multi-modal converter for generating visual-based multi-modal content in response to the second browsing request.

### BRIEF DESCRIPTION OF THE DRAWINGS

For a better understanding of the nature of the features of the invention, reference should be made to the following detailed description taken in conjunction with the accompanying drawings, in which:

FIG. 1 provides a schematic diagram of a system for accessing Web content using a voice browser system in accordance with the present invention.

FIG. 2 shows a block diagram of a voice browser included within the system of FIG. 1.

FIG. 3 is a functional block diagram of a conversion server.

FIG. 4 is a flow chart representative of operation of the system of FIG. 1 in furnishing Web content to a requesting user.

FIG. 5 is a flow chart representative of operation of the system of FIG. 1 in providing content from a proprietary database to a requesting user.

FIG. 6 is a flow chart representative of operation of the conversion server of FIG. 3.

FIG. 7A and 7B are collectively a flowchart illustrating an exemplary process for transcoding a parse tree representation of WML-based document into an output document comporting with the VoiceXML protocol.

FIGS. 8A and 8B illustratively represent a wireless communication system incorporating a multi-mode gateway controller of the present invention disposed within a wireless operator facility.

FIG. 9 provides an alternate block diagrammatic representation of a multi-modal communication system of the present invention.

FIG. 10 is a flow chart representative of an exemplary two-step registration process for determining whether a given subscriber unit is configured with WAP-based and/or SMS-based communication capability.

### DETAILED DESCRIPTION OF THE INVENTION

### INTRODUCTORY OVERVIEW

The present invention provides a system and method for transferring information in multi-modal form (e.g., simultaneously in both visual and voice form) in accord with user preference. Given the extensive amounts of content available in various standardized visual and voice-based formats, it would likely be difficult to foster acceptance of a new standard directed to multi-modal content. Accordingly, the present invention advantageously provides a technique which enables existing visual and the voice-based content to be combined and delivered to users in multi-modal form. In the exemplary embodiment the user is provided with the opportunity to select the mode of information presentation and to switch between such presentation modes.

As is described herein, the method of the invention permits a user to interact with different sections of existing content using either a visual or voice-based communication modes. The decision as to whether to “see” or “listen” to a particular section of content will generally depend upon either or both of the type of the content being transferred and the context in which the user is communicating.

### EXEMPLARY SINGLE-MODE INFORMATION RETRIEVAL SYSTEM

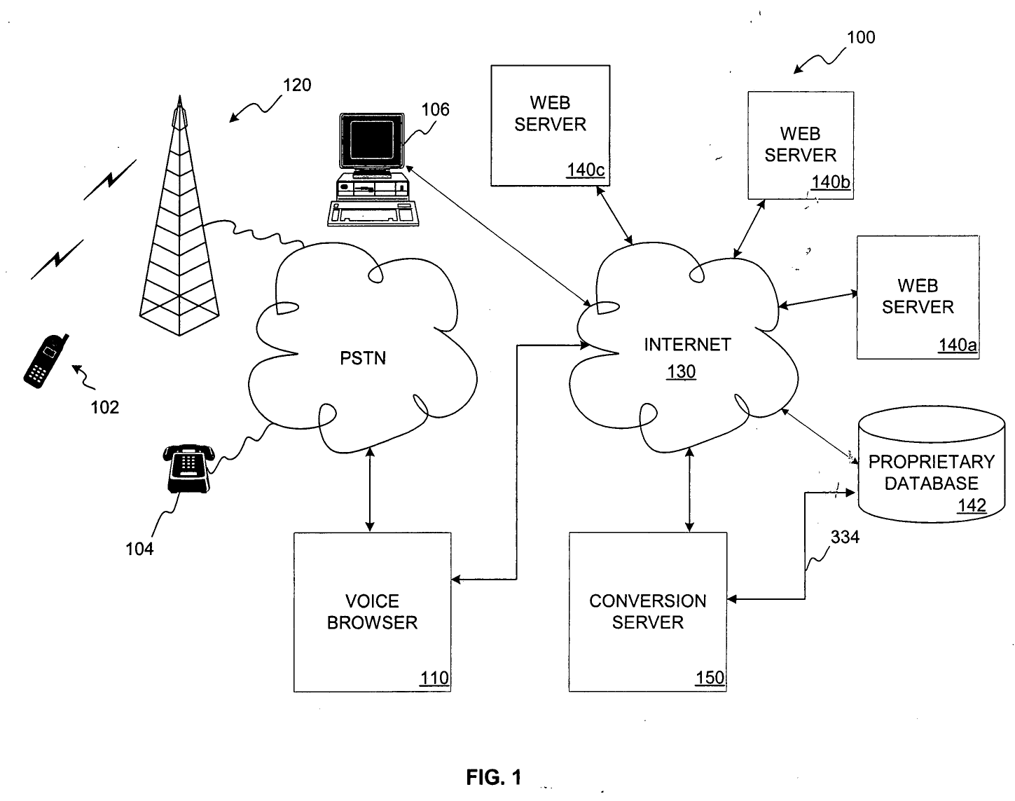

FIG. 1 provides a schematic diagram of a system 100 for accessing Web content using a voice browser in a primarily single-mode fashion. It is anticipated that an understanding of the single-mode system of FIG. 1 will facilitate appreciation of certain aspects of the operation of the multi-mode information retrieval contemplated by the present invention. In addition, an exemplary embodiment the multi-modal retrieval system of the present invention incorporates certain functionality of the single-mode information retrieval described herein with reference to FIG. 1. Referring to FIG. 1, the system 100 includes a telephonic subscriber unit 102 in communication with a voice browser 110 through a telecommunications network 120. In an exemplary embodiment the voice browser 110 executes dialogues with a user of the subscriber unit 102 on the basis of document files comporting with a known speech mark-up language (e.g., VoiceXML). The voice browser 110 initiates, in response to requests for content submitted through the subscriber unit 102, the retrieval of information forming the basis of certain such document files from remote information sources. Such remote information sources may comprise, for example, Web servers 140 and one or more databases represented by proprietary database 142.

As is described hereinafter, the voice browser 110 initiates such retrieval by issuing a browsing request either directly to the applicable remote information source or to a conversion server 150. In particular, if the request for content pertains to a remote information source operative in accordance with the protocol applicable to the voice browser 110 (e.g., VoiceXML), then the voice browser 110 issues a browsing request directly to the remote information source of interest. For example, when the request for content pertains to a Web site formatted consistently with the protocol of the voice browser 110, a document file containing such content is requested by the voice browser 110 via the Internet 130 directly from the Web server 140 hosting the Web site of interest. On the other hand, when a request for content issued through the subscriber unit 102 identifies a Web site formatted inconsistently with the voice browser 110, the voice browser 110 issues a corresponding browsing request to a conversion server 150. In response, the conversion server 150 retrieves content from the Web server 140 hosting the Web site of interest and converts this content into a document file compliant with the protocol of the voice browser 110. The converted document file is then provided by the conversion server 150 to the voice browser 110, which then uses this file to effect a dialogue conforming to the applicable voice-based protocol with the user of subscriber unit 102. Similarly, when a request for content identifies a proprietary database 142, the voice browser 110 issues a corresponding browsing request to the conversion server 150. In response, the conversion server 150 retrieves content from the proprietary database 142 and converts this content into a document file compliant with the protocol of the voice browser 110. The converted document file is then provided to the voice browser 110 and used as the basis for carrying out a dialogue with the user of subscriber unit 102.

As shown in FIG. 1, the subscriber unit 102 is in communication with the voice browser 110 via the telecommunications network 120. The subscriber unit 102 has a keypad (not shown) and associated circuitry for generating Dual Tone MultiFrequency (DTMF) tones. The subscriber unit 102 transmits DTMF tones to, and receives audio output from, the voice browser 110 via the telecommunications network 120. In FIG. 1, the subscriber unit 102 is exemplified with a mobile station and the telecommunications network 120 is represented as including a mobile communications network and the Public Switched Telephone Network (“PSTN”). However, the voice-based information retrieval services offered by the system 100 can be accessed by subscribers through a variety of other types of devices and networks. For example, the voice browser 110 may be accessed through the PSTN from, for example, a stand-alone telephone 104 (either analog or digital), or from a node on a PBX (not shown). In addition, a personal computer 106 or other handheld or portable computing device disposed for voice over IP communication may access the voice browser 110 via the Internet 130.

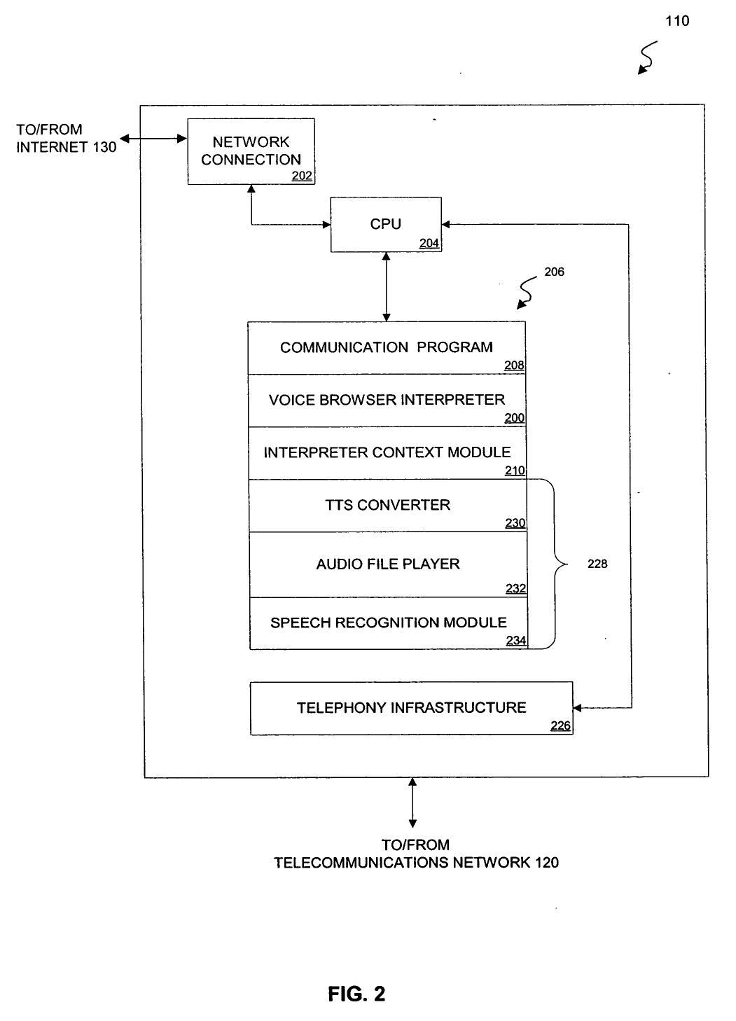

FIG. 2 shows a block diagram of the voice browser 110. The voice browser 110 includes certain standard server computer components, including a network connection device 202, a CPU 204 and memory (primary and/or secondary) 206. The voice browser 110 also includes telephony infrastructure 226 for effecting communication with telephony-based subscriber units (e.g., the mobile subscriber unit 102 and landline telephone 104). As is described below, the memory 206 stores a set of computer programs to implement the processing effected by the voice browser 110. One such program stored by memory 206 comprises a standard communication program 208 for conducting standard network communications via the Internet 130 with the conversion server 150 and any subscriber units operating in a voice over IP mode (e.g., personal computer 106).

As shown, the memory 206 also stores a voice browser interpreter 200 and an interpreter context module 210. In response to requests from, for example, subscriber unit 102 for Web or proprietary database content formatted inconsistently with the protocol of the voice browser 110, the voice browser interpreter 200 initiates establishment of a communication channel via the Internet 130 with the conversion server 150. The voice browser 110 then issues, over this communication channel and in accordance with conventional Internet protocols (i.e., HTTP and TCP/IP), browsing requests to the conversion server 150 corresponding to the requests for content submitted by the requesting subscriber unit. The conversion server 150 retrieves the requested Web or proprietary database content in response to such browsing requests and converts the retrieved content into document files in a format (e.g., VoiceXML) comporting with the protocol of the voice browser 110. The converted document files are then provided to the voice browser 110 over the established Internet communication channel and utilized by the voice browser interpreter 200 in carrying out a dialogue with a user of the requesting unit. During the course of this dialogue the interpreter context module 210 uses conventional techniques to identify requests for help and the like which may be made by the user of the requesting subscriber unit. For example, the interpreter context module 210 may be disposed to identify predefined “escape” phrases submitted by the user in order to access menus relating to, for example, help functions or various user preferences (e.g., volume, text-to-speech characteristics).

Referring to FIG. 2, audio content is transmitted and received by telephony infrastructure 226 under the direction of a set of audio processing modules 228. Included among the audio processing modules 228 are a text-to-speech (“TTS”) converter 230, an audio file player 232, and a speech recognition module 234. In operation, the telephony infrastructure 226 is responsible for detecting an incoming call from a telephony-based subscriber unit and for answering the call (e.g., by playing a predefined greeting). After a call from a telephony-based subscriber unit has been answered, the voice browser interpreter 200 assumes control of the dialogue with the telephony-based subscriber unit via the audio processing modules 228. In particular, audio requests from telephony-based subscriber units are parsed by the speech recognition module 234 and passed to the voice browser interpreter 200. Similarly, the voice browser interpreter 200 communicates information to telephony-based subscriber units through the text-to-speech converter 230. The telephony infrastructure 226 also receives audio signals from telephony-based subscriber units via the telecommunications network 120 in the form of DTMF signals. The telephony infrastructure 226 is able to detect and interpret the DTMF tones sent from telephony-based subscriber units. Interpreted DTMF tones are then transferred from the telephony infrastructure to the voice browser interpreter 200.

After the voice browser interpreter 200 has retrieved a VoiceXML document from the conversion server 150 in response to a request from a subscriber unit, the retrieved VoiceXML document forms the basis for the dialogue between the voice browser 110 and the requesting subscriber unit. In particular, text and audio file elements stored within the retrieved VoiceXML document are converted into audio streams in text-to-speech converter 230 and audio file player 232, respectively. When the request for content associated with these audio streams originated with a telephony-based subscriber unit, the streams are transferred to the telephony infrastructure 226 for adaptation and transmission via the telecommunications network 120 to such subscriber unit. In the case of requests for content from Internet-based subscriber units (e.g., the personal computer 106), the streams are adapted and transmitted by the network connection device 202.

The voice browser interpreter 200 interprets each retrieved VoiceXML document in a manner analogous to the manner in which a standard Web browser interprets a visual markup language, such as HTML or WML. The voice browser interpreter 200, however, interprets scripts written in a speech markup language such as VoiceXML rather than a visual markup language. In a preferred embodiment the voice browser 110 may be realized using, consistent with the teachings herein, a voice browser licensed from, for example, Nuance Communications of Menlo Park, Calif.

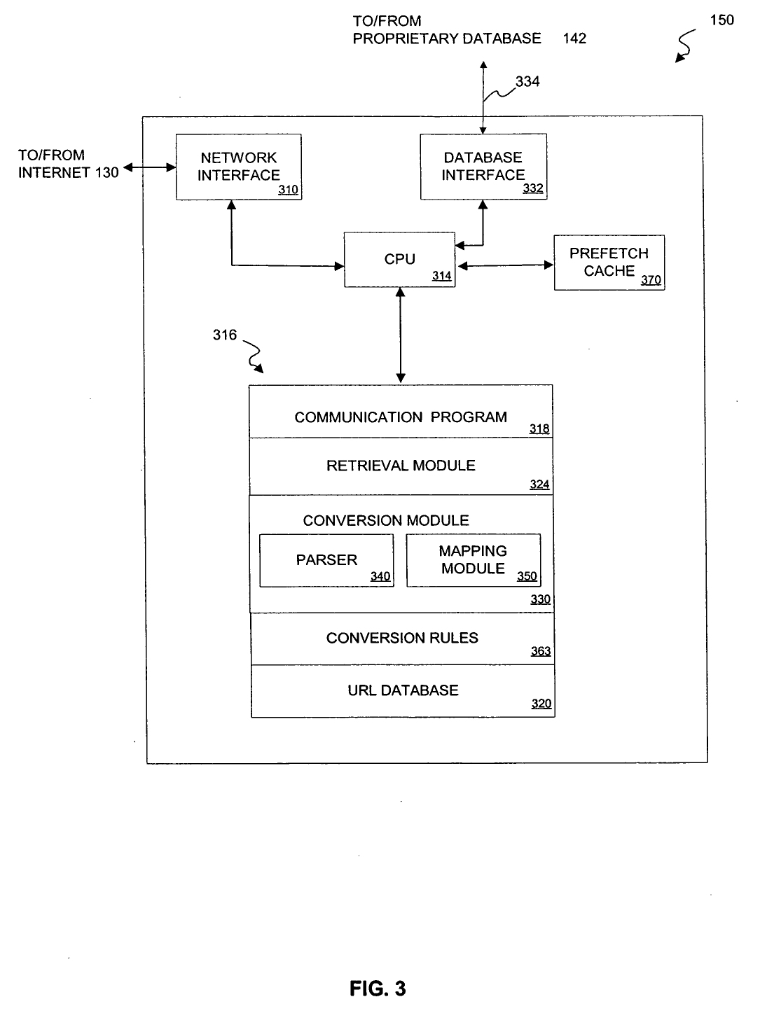

Turning now to FIG. 3, a functional block diagram is provided of the conversion server 150. As is described below, the conversion server 150 operates to convert or transcode conventional structured document formats (e.g., HTML) into the format applicable to the voice browser 110 (e.g., VoiceXML). This conversion is generally effected by performing a predefined mapping of the syntactical elements of conventional structured documents harvested from Web servers 140 into corresponding equivalent elements contained within an XML-based file formatted in accordance with the protocol of the voice browser 110. The resultant XML-based file may include all or part of the “target” structured document harvested from the applicable Web server 140, and may also optionally include additional content provided by the conversion server 150. In the exemplary embodiment the target document is parsed, and identified tags, styles and content can either be replaced or removed.

The conversion server 150 may be physically implemented using a standard configuration of hardware elements including a CPU 314, a memory 316, and a network interface 310 operatively connected to the Internet 130. Similar to the voice browser 110, the memory 316 stores a standard communication program 318 to realize standard network communications via the Internet 130. In addition, the communication program 318 also controls communication occurring between the conversion server 150 and the proprietary database 142 by way of database interface 332. As is discussed below, the memory 316 also stores a set of computer programs to implement the content conversion process performed by the conversion module 150.

Referring to FIG. 3, the memory 316 includes a retrieval module 324 for controlling retrieval of content from Web servers 140 and proprietary database 142 in accordance with browsing requests received from the voice browser 110. In the case of requests for content from Web servers 140, such content is retrieved via network interface 310 from Web pages formatted in accordance with protocols particularly suited to portable, handheld or other devices having limited display capability (e.g., WML, Compact HTML, xHTML and HDML). As is discussed below, the locations or URLs of such specially formatted sites may be provided by the voice browser or may be stored within a URL database 320 of the conversion server 150. For example, if the voice browser 110 receives a request from a user of a subscriber unit for content from the “CNET” Web site, then the voice browser 110 may specify the URL for the version of the “CNET” site accessed by WAP-compliant devices (i.e., comprised of WML-formatted pages). Alternatively, the voice browser 110 could simply proffer a generic request for content from the “CNET” site to the conversion server 150, which in response would consult the URL database 320 to determine the URL of an appropriately formatted site serving “CNET” content.

The memory 316 of conversion server 150 also includes a conversion module 330 operative to convert the content collected under the direction of retrieval module 324 from Web servers 140 or the proprietary database 142 into corresponding VoiceXML documents. As is described below, the retrieved content is parsed by a parser 340 of conversion module 330 in accordance with a document type definition (“DTD”) corresponding to the format of such content. For example, if the retrieved Web page content is formatted in WML, the parser 340 would parse the retrieved content using a DTD obtained from the applicable standards body, i.e., the Wireless Application Protocol Forum, Ltd. (www.wapforum.org) into a parsed file. A DTD establishes a set of constraints for an XML-based document; that is, a DTD defines the manner in which an XML-based document is constructed. The resultant parsed file is generally in the form of a Domain Object Model (“DOM”) representation, which is arranged in a tree-like hierarchical structure composed of a plurality of interconnected nodes (i.e., a “parse tree”). In the exemplary embodiment the parse tree includes a plurality of “child” nodes descending downward from its root node, each of which are recursively examined and processed in the manner described below.

A mapping module 350 within the conversion module 330 then traverses the parse tree and applies predefined conversion rules 363 to the elements and associated attributes at each of its nodes. In this way the mapping module 350 creates a set of corresponding equivalent elements and attributes conforming to the protocol of the voice browser 110. A converted document file (e.g., a VoiceXML document file) is then generated by supplementing these equivalent elements and attributes with grammatical terms to the extent required by the protocol of the voice browser 110. This converted document file is then provided to the voice browser 110 via the network interface 310 in response to the browsing request originally issued by the voice browser 110.

The conversion module 330 is preferably a general purpose converter capable of transforming the above-described structured document content (e.g., WML) into corresponding VoiceXML documents: The resultant VoiceXML content can then be delivered to users via any VoiceXML-compliant platform, thereby introducing a voice capability into existing structured document content. In a particular embodiment, a basic set of rules can be imposed to simplify the conversion of the structured document content into the VoiceXML format. An exemplary set of such rules utilized by the conversion module 330 may comprise the following.

1. If the structured document content (e.g., WML pages) comprises images, the conversion module 330 will discard the images and generate the necessary information for presenting the image.

2. If the structured document content comprises scripts, data or some other component not capable of being presented by voice, the conversion module 330 may generate appropriate warning messages or the like. The warning message will typically inform the user that the structured content contains a script or some component not capable of being converted to voice and that meaningful information may not be being conveyed to the user.

3. When the structured document content contains instructions similar or identical to those such as the WML-based SELECT LIST options, the conversion module 330 generates information for presenting the SELECT LIST or similar options into a menu list for audio representation. For example, an audio playback of “Please say news weather mail” could be generated for the SELCT LIST defining the three options of news, weather and mail.

4. Any hyperlinks in the structured document content are converted to reference the conversion module 330, and the actual link location passed to the conversion module as a parameter to the referencing hyperlink. In this way hyperlinks and other commands which transfer control may be voice-activated and converted to an appropriate voice-based format upon request.

5. Input fields within the structured content are converted to an active voice-based dialogue, and the appropriate commands and vocabulary added as necessary to process them.

6. Multiple screens of structured content (e.g., card-based WML screens) can be directly converted by the conversion module 330 into forms or menus of sequential dialogs. Each menu is a stand-alone component (e.g., performing a complete task such as receiving input data). The conversion module 330 may also include a feature that permits a user to interrupt the audio output generated by a voice platform (e.g., BeVocal, HeyAnita) prior to issuing a new command or input.

7. For all those events and “do” type actions similar to WML-based “OK”, “Back” and “Done” operations, voice-activated commands may be employed to straightforwardly effect such actions.

8. In the exemplary embodiment the conversion module 330 operates to convert an entire page of structured content at once and to play the entire page in an uninterrupted manner. This enables relatively lengthy structured documents to be presented without the need for user intervention in the form of an audible “More” command or the equivalent.

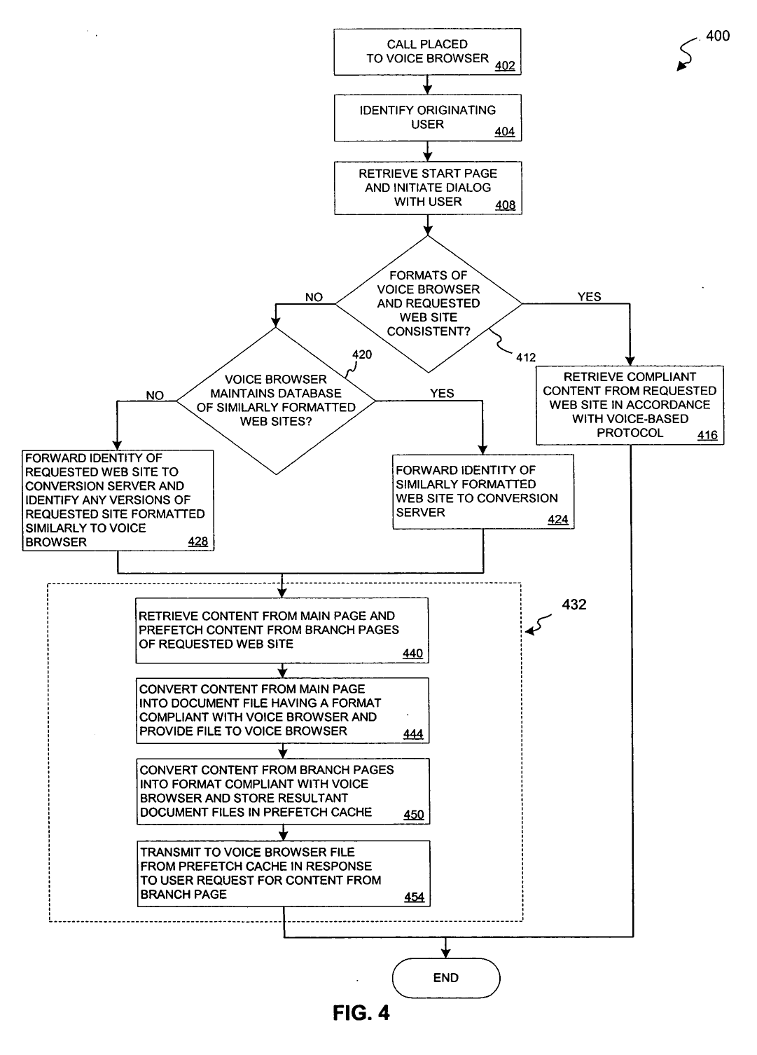

FIG. 4 is a flow chart representative of an exemplary process 400 executed by the system 100 in providing content from Web servers 140 to a user of a subscriber unit. At step 402, the user of the subscriber unit places a call to the voice browser 110, which will then typically identify the originating user utilizing known techniques (step 404). The voice browser then retrieves a start page associated with such user, and initiates execution of an introductory dialogue with the user such as, for example, the dialogue set forth below (step 408). In what follows the designation “C” identifies the phrases generated by the voice browser 110 and conveyed to the user's subscriber unit, and the designation “U” identifies the words spoken or actions taken by such user.
C: “Welcome home, please say the name of the Web site which you would like to access”
U: “CNET dot com”
C: “Connecting, please wait . . .”
C: “Welcome to CNET, please say one of: sports; weather; business; news; stock quotes”
U: “Sports”

The manner in which the system 100 processes and responds to user input during a dialogue such as the above will vary depending upon the characteristics of the voice browser 110. Referring again to FIG. 4, in a step 412 the voice browser checks to determine whether the requested Web site is of a format consistent with its own format (e.g., VoiceXML). If so, then the voice browser 110 may directly retrieve content from the Web server 140 hosting the requested Web site (e.g., “vxml.cnet.com”) in a manner consistent with the applicable voice-based protocol (step 416). If the format of the requested Web site (e.g., “cnet.com”) is inconsistent with the format of the voice browser 110, then the intelligence of the voice browser 110 influences the course of subsequent processing. Specifically, in the case where the voice browser 110 maintains a database (not shown) of Web sites having formats similar to its own (step 420), then the voice browser 110 forwards the identity of such similarly formatted site (e.g., “wap.cnet.com”) to the conversion server 150 via the Internet 130 in the manner described below (step 424). If such a database is not maintained by the voice browser 110, then in a step 428 the identity of the requested Web site itself (e.g., “cnet.com”) is similarly forwarded to the conversion server 150 via the Internet 130. In the latter case the conversion server 150 will recognize that the format of the requested Web site (e.g., HTML) is dissimilar from the protocol of the voice browser 110, and will then access the URL database 320 in order to determine whether there exists a version of the requested Web site of a format (e.g., WML) more easily convertible into the protocol of the voice browser 110. In this regard it has been found that display protocols adapted for the limited visual displays characteristic of handheld or portable devices (e.g., WAP, HDML, iMode, Compact HTML or XML) are most readily converted into generally accepted voice-based protocols (e.g., VoiceXML), and hence the URL database 320 will generally include the URLs of Web sites comporting with such protocols. Once the conversion server 150 has determined or been made aware of the identity of the requested Web site or of a corresponding Web site of a format more readily convertible to that of the voice browser 110, the conversion server 150 retrieves and converts Web content from such requested or similarly formatted site in the manner described below(step 432).

In accordance with the invention, the voice-browser 110 is disposed to use substantially the same syntactical elements in requesting the conversion server 150 to obtain content from Web sites not formatted in conformance with the applicable voice-based protocol as are used in requesting content from Web sites compliant with the protocol of the voice browser 110. In the case where the voice browser 110 operates in accordance with the VoiceXML protocol, it may issue requests to Web servers 140 compliant with the VoiceXML protocol using, for example, the syntactical elements goto, choice, link and submit. As is described below, the voice browser 110 may be configured to request the conversion server 150 to obtain content from inconsistently formatted Web sites using these same syntactical elements. For example, the voice browser 110 could be configured to issue the following type of goto when requesting Web content through the conversion server 150:

<goto next=http://ConSeverAddress:tportIFilename?URL=ContentAddress&Protocol/>

where the variable ConSeverAddress within the next attribute of the goto element is set to the IP address of the conversion server 150, the variable Filename is set to the name of a conversion script (e.g., conversion.jsp) stored on the conversion server 150, the variable ContentAddress is used to specify the destination URL (e.g., “wap.cnet.com”) of the Web server 140 of interest, and the variable Protocol identifies the format (e.g., WAP) of such content server. The conversion script is typically embodied in a file of conventional format (e.g., files of type “jsp”, “.asp” or “.cgi”). Once this conversion script has been provided with this destination URL, Web content is retrieved from the applicable Web server 140 and converted by the conversion script into the VoiceXML format per the conversion process described below.

The voice browser 110 may also request Web content from the conversion server 150 using the choice element defined by the VoiceXML protocol. Consistent with the VoiceXML protocol, the choice element is utilized to define potential user responses to queries posed within a menu construct. In particular, the menu construct provides a mechanism for prompting a user to make a selection, with control over subsequent dialogue with the user being changed on the basis of the user's selection. The following is an exemplary call for Web content which could be issued by the voice browser 110 to the conversion server 150 using the choice element in a manner consistent with the invention:

<choice next=“http://ConSeverAddress:port/Conversion.jsp?URL=ContentAddress&Protocol/”>

The voice browser 110 may also request Web content from the conversion server 150 using the link element, which may be defined in a VoiceXML document as a child of the vxml or form constructs. An example of such a request based upon a link element is set forth below:

<link next=“Conversion.jsp?URL=ContentAddress&Protocol/”>

Finally, the submit element is similar to the goto element in that its execution results in procurement of a specified VoiceXML document. However, the submit element also enables an associated list of variables to be submitted to the identified Web server 140 by way of an HTTP GET or POST request. An exemplary request for Web content from the conversion server 150 using a submit expression is given below:

<submit next=“htttp://http://ConSeverAddress:port//Conversion.jsp?URL=ContentAddress&Protocol method=” “post” namelist=“siteprotocol”/>

where the method attribute of the submit element specifies whether an HTTP GET or POST method will be invoked, and where the namelist attribute identifies a site protocol variable forwarded to the conversion server 150. The site protocol variable is set to the formatting protocol applicable to the Web site specified by the ContentAddress variable.

As is described in detail below, the conversion server 150 operates to retrieve and convert Web content from the Web servers 140 in a unique and efficient manner (step 432). This retrieval process preferably involves collecting Web content not only from a “root” or “main” page of the Web site of interest, but also involves “prefetching” content from “child” or “branch” pages likely to be accessed from such main page (step 440). In a preferred implementation the content of the retrieved main page is converted into a document file having a format consistent with that of the voice browser 110. This document file is then provided to the voice browser 110 over the Internet by the interface 310 of the conversion server 150, and forms the basis of the continuing dialogue between the voice browser 110 and the requesting user (step 444). The conversion server 150 also immediately converts the “prefectched” content from each branch page into the format utilized by the voice browser 110 and stores the resultant document files within a prefetch cache 370 (step 450). When a request for content from such a branch page is issued to the voice browser 110 through the subscriber unit of the requesting user, the voice browser 110 forwards the request in the above-described manner to the conversion server 150. The document file corresponding to the requested branch page is then retrieved from the prefetch cache 370 and provided to the voice browser 110 through the network interface 310. Upon being received by the voice browser 110, this document file is used in continuing a dialogue with the user of subscriber unit 102 (step 454). It follows that once the user has begun a dialogue with the voice browser 110 based upon the content of the main page of the requested Web site, such dialogue may continue substantially uninterrupted when a transitions is made to one of the prefetched branch pages of such site. This approach advantageously minimizes the delay exhibited by the system 100 in responding to subsequent user requests for content once a dialogue has been initiated.

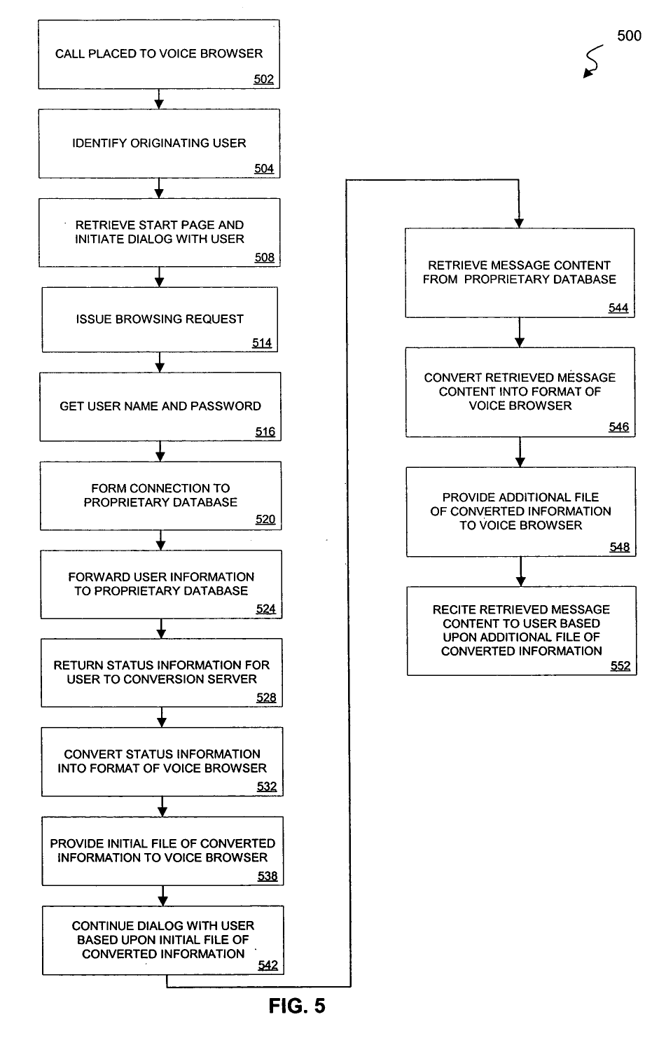

FIG. 5 is a flow chart representative of operation of the system 100 in providing content from proprietary database 142 to a user of a subscriber unit. In the exemplary process 500 represented by FIG. 5, the proprietary database 142 is assumed to comprise a message repository included within a text-based messaging system (e.g., an electronic mail system) compliant with the ARPA standard set forth in Requests for Comments (RFC) 822, which is entitled “RFC822: Standard for ARPA Internet Text Messages” and is available at, for example, www.w3.org/Protocols/rfc822/Overview.html. Referring to FIG. 5, at a step 502 a user of a subscriber unit places a call to the voice browser 110. The originating user is then identified by the voice browser 110 utilizing known techniques (step 504). The voice browser 110 then retrieves a start page associated with such user, and initiates execution of an introductory dialogue with the user such as, for example, the dialogue set forth below (step 508).
C: “What do you want to do?”
U: “Check Email”
C: “Please wait”

In response to the user's request to “Check Email”, the voice browser 110 issues a browsing request to the conversion server 150 in order to obtain information applicable to the requesting user from the proprietary database 142 (step 514). In the case where the voice browser 110 operates in accordance with the VoiceXML protocol, it issues such browsing request using the syntactical elements goto, choice, link and submit in a substantially similar manner as that described above with reference to FIG. 4. For example, the voice browser 110 could be configured to issue the following type of goto when requesting information from the proprietary database 142 through the conversion server 150:

<goto next=http://ConServerAddress:port/email.jsp?=ServerAddress&Protocol/>

where email.jsp is a program file stored within memory 316 of the conversion server 150, ServerAddress is a variable identifying the address of the proprietary database 142 (e.g., mail.V-Enable.com), and Protocol is a variable identifying the format of the database 142 (e.g., POP3).

Upon receiving such a browsing request from the voice browser 110, the conversion server 150 initiates execution of the email.jsp program file. Under the direction of email.jsp, the conversion server 150 queries the voice browser 110 for the user name and password of the requesting user (step 516) and stores the returned user information UserInfo within memory 316. The program email.jsp then calls function EmailFromUser, which forms a connection to ServerAddress based upon the Transport Control Protocol (TCP) via dedicated communication link 334 (step 520). The function EmailFromUser then invokes the method CheckEmail and furnishes the parameters ServerAddress, Protocol, and UserInfo to such method during the invocation process. Upon being invoked, CheckEmail forwards UserInfo over communication link 334 to the proprietary database 142 in accordance with RFC 822 (step 524). In response, the proprietary database 142 returns status information (e.g., number of new messages) for the requesting user to the conversion server 150 (step 528). This status information is then converted by the conversion server 150 into a format consistent with the protocol of the voice browser 110 using techniques described below (step 532). The resultant initial file of converted information is then provided to the voice browser 110 over the Internet by the network interface 310 of the conversion server 150 (step 538). Dialogue between the voice browser 110 and the user of the subscriber unit may then continue as follows based upon the initial file of converted information (step 542):
C: “You have 3 new messages”
C: “First message”

Upon forwarding the initial file of converted information to the voice browser 110, CheckEmail again forms a connection to the proprietary database 142 over dedicated communication link 334 and retrieves the content of the requesting user's new messages in accordance with RFC 822 (step 544). The retrieved message content is converted by the conversion server 150 into a format consistent with the protocol of the voice browser 110 using techniques described below (step 546). The resultant additional file of converted information is then provided to the voice browser 110 over the Internet by the network interface 310 of the conversion server 150 (step 548). The voice browser 110 then recites the retrieved message content to the requesting user in accordance with the applicable voice-based protocol based upon the additional file of converted information (step 552).

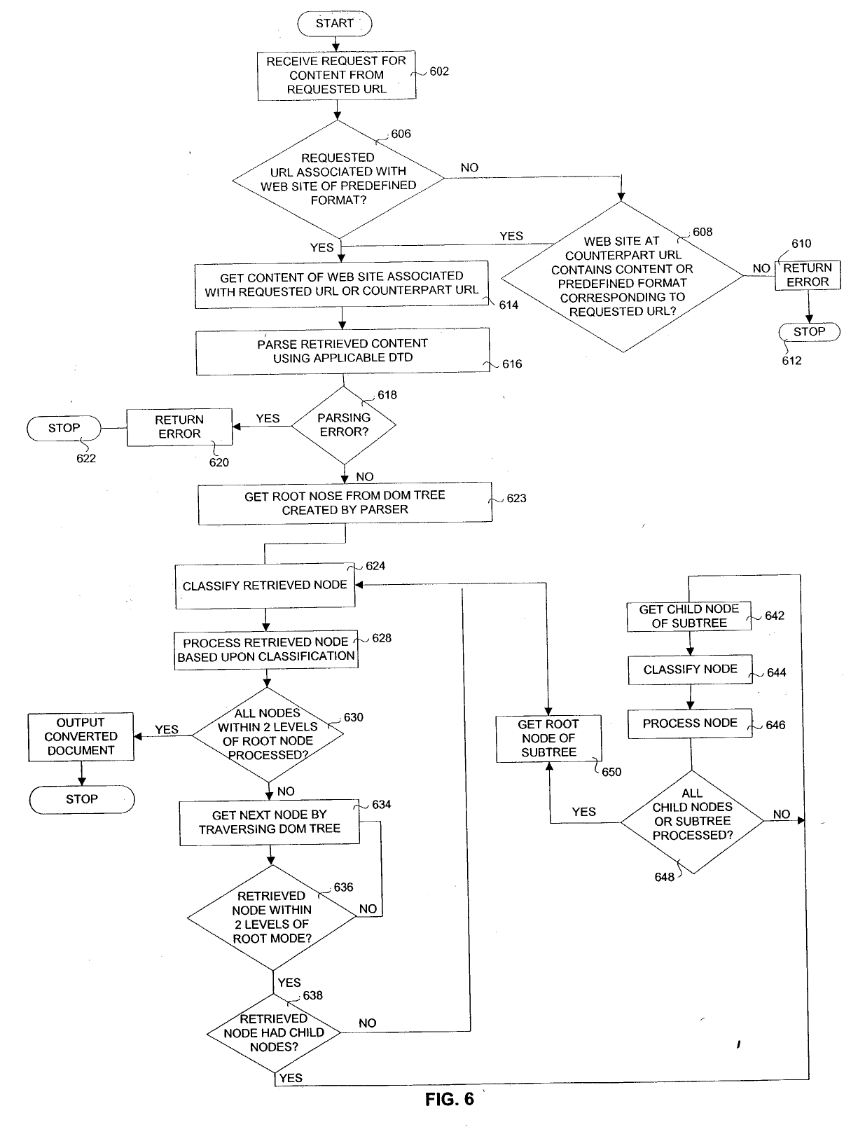

FIG. 6 is a flow chart representative of operation of the conversion server 150. A source code listing of a top-level convert routine forming part of an exemplary software implementation of the conversion operation illustrated by FIG. 6 is contained in Appendix A. In addition, Appendix B provides an example of conversion of a WML-based document into VoiceXML-based grammatical structure in accordance with the present invention. Referring to step 602 of FIG. 6, the conversion server 150 receives one or more requests for Web content transmitted by the voice browser 110 via the Internet 130 using conventional protocols (i.e., HTTP and TCP/IP). The conversion module 330 then determines whether the format of the requested Web site corresponds to one of a number of predefined formats (e.g., WML) readily convertible into the protocol of the voice browser 110 (step 606). If not, then the URL database 320 is accessed in order to determine whether there exists a version of the requested Web site formatted consistently with one of the predefined formats (step 608). If not, an error is returned (step 610) and processing of the request for content is terminated (step 612). Once the identity of the requested Web site or of a counterpart Web site of more appropriate format has been determined, Web content is retrieved by the retrieval module 310 of the conversion server 150 from the applicable content server 140 hosting the identified Web site (step 614).

Once the identified Web-based or other content has been retrieved by the retrieval module 310, the parser 340 is invoked to parse the retrieved content using the DTD applicable to the format of the retrieved content (step 616). In the event of a parsing error (step 618), an error message is returned (step 620) and processing is terminated (step 622). A root node of the DOM representation of the retrieved content generated by the parser 340, i.e., the parse tree, is then identified (step 623). The root node is then classified into one of a number of predefined classifications (step 624). In the exemplary embodiment each node of the parse tree is assigned to one of the following classifications: Attribute, CDATA, Document Fragment, Document Type, Comment, Element, Entity Reference, Notation, Processing Instruction, Text. The content of the root node is then processed in accordance with its assigned classification in the manner described below (step 628). If all nodes within two tree levels of the root node have not been processed (step 630), then the next node of the parse tree generated by the parser 340 is identified (step 634). If not, conversion of the desired portion of the retrieved content is deemed completed and an output file containing such desired converted content is generated.

If the node of the parse tree identified in step 634 is within two levels of the root node (step 636), then it is determined whether the identified node includes any child nodes (step 638). If not, the identified node is classified (step 624). If so, the content of a first of the child nodes of the identified node is retrieved (step 642). This child node is assigned to one of the predefined classifications described above (step 644) and is processed accordingly (step 646). Once all child nodes of the identified node have been processed (step 648), the identified node (which corresponds to the root node of the subtree containing the processed child nodes) is itself retrieved (step 650) and assigned to one of the predefined classifications (step 624).

Appendix C contains a source code listing for a TraverseNode function which implements various aspects of the node traversal and conversion functionality described with reference to FIG. 6. In addition, Appendix D includes a source code listing of a ConvertAtr function, and of a ConverTag function referenced by the TraverseNode function, which collectively operate to WML tags and attributes to corresponding VoiceXML tags and attributes.

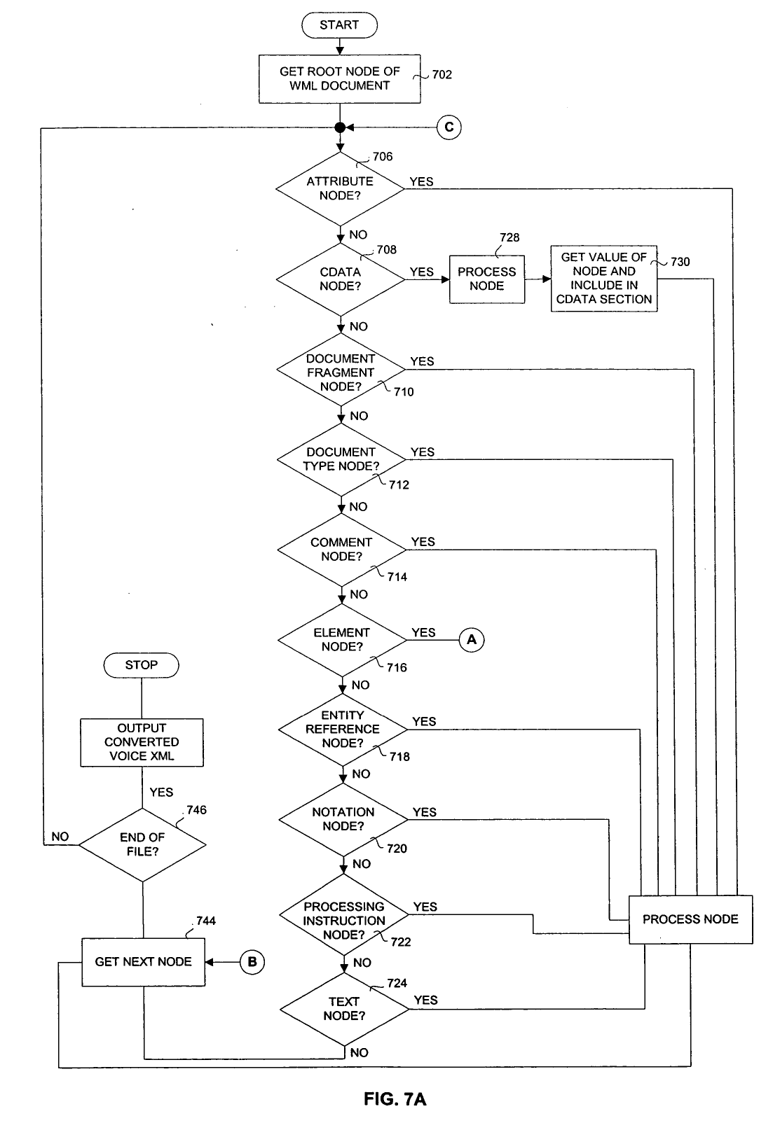

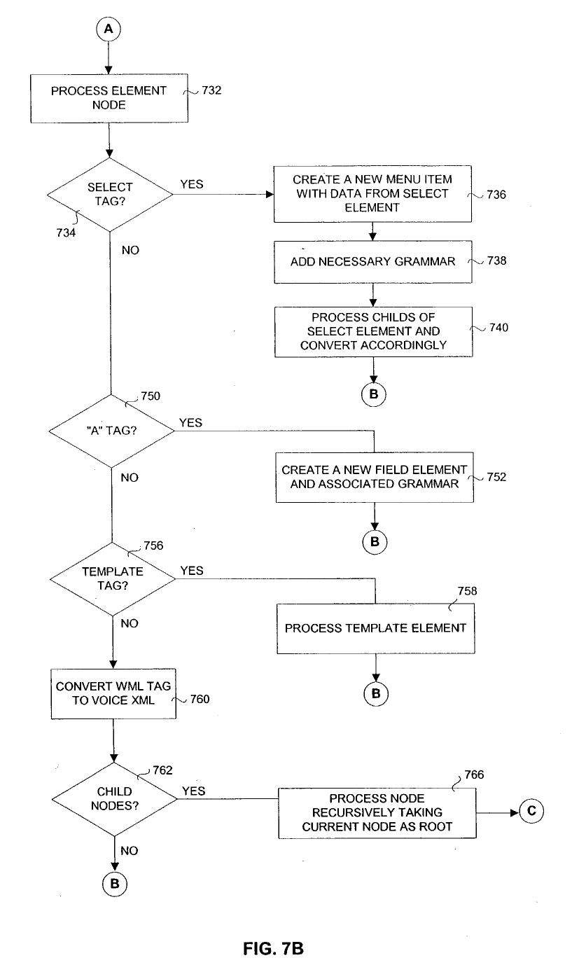

FIGS. 7A and 7B are collectively a flowchart illustrating an exemplary process for transcoding a parse tree representation of an WML-based document into an output document comporting with the VoiceXML protocol. Although FIG. 7 describes the inventive transcoding process with specific reference to the WML and VoiceXML protocols, the process is also applicable to conversion between other visual-based and voice-based protocols. In step 702, a root node of the parse tree for the target WML document to be transcoded is retrieved. The type of the root node is then determined and, based upon this identified type, the root node is processed accordingly. Specifically, the conversion process determines whether the root node is an attribute node (step 706), a CDATA node (step 708), a document fragment node (step 710), a document type node (step 712), a comment node (step 714), an element node (step 716), an entity reference node (step 718), a notation node (step 720), a processing instruction node (step 722), or a text node (step 724).

In the event the root node is determined to reference information within a CDATA block, the node is processed by extracting the relevant CDATA information (step 728). In particular, the CDATA information is acquired and directly incorporated into the converted document without modification (step 730). An exemplary WML-based CDATA block and its corresponding representation in VoiceXML is provided below.

```
WML-Based CDATA Block
<?xml version=“1.0” ?>
<!DOCTYPE wml PUBLIC “-//WAPFORUM//DTD WML 1.1//EN”
“http://www.wapforum.org/DTD/wml_1.1.xml” >
<wml>
  <card>
    <p>
      <![CDATA[
        .....
        .....
        .....
      ]]>
    </p>
  </card>
</wml>
VoiceXML Representation of CDATA Block
<?xml version=“1.0” ?>
<vxml>
  <form>
    <block>
      <![CDATA[
        .....
        .....
        .....
      ]]>
    </block>
  </form>
</vxml>
```

If it is established that the root node is an element node (step 716), then processing proceeds as depicted in FIG. 7B (step 732). If a Select tag is found to be associated with the root node (step 734), then a new menu item is created based upon the data comprising the identified select tag (step 736). Any grammar necessary to ensure that the new menu item comports with the VoiceXML protocol is then added (step 738).

The operations defined by the WML-based Select tag are mapped to corresponding operations presented through the VoiceXML-based Menu tag. The Select tag is typically utilized to specify a visual list of user options and to define corresponding actions to be taken depending upon the option selected. Similarly, a Menu tag in VoiceXML specifies an introductory message and a set of spoken prompts corresponding to a set of choices. The Menu tag also specifies a corresponding set of possible responses to the prompts, and will typically also specify a URL to which a user is directed upon selecting a particular choice. When the grammatical structure defined by a Menu tag is visited, its introductory text is spoken followed by the prompt text of any contained Choice tags. A grammar for matching the “title” text of the grammatical structure defined by a Menu tag may be activated upon being loaded. When a word or phrase which matches the title text of a Menu tag is spoken by a user, the user is directed to the grammatical structure defined by the Menu tag.

The following exemplary code corresponding to a WML-based Select operation and a corresponding VoiceXML-based Menu operation illustrates this conversion process. Each operation facilitates presentation of a set of four potential options for selection by a user: “cnet news”, “V-enable”, “Yahoo stocks”, and “Wireless Knowledge”

```
Select operation
<select ivalue=”1” name=”action”>
    <option title=”OK” onpick=”http://cnet.news.com>Cnet news</option>
    <option title=”OK” onpick=”http://www.v-enable.com>V-enable/option>
    <option title=”OK” onpick=”http://stocks.yahoo.com>Yahoo stocks</option>
    <option  title=”OK”  onpick=”http://www.wirelessknowledge.com”>Visit  Wireless
    Knowledge</option>
</select>
Menu operation
<menu id=“mainMenu” >
  <prompt>Please choose from <enumerate/> </prompt>
      <choice  next=“http://server:port/Convert.jsp?url=http://cnet.news.com”>  Cnet news
      </choice>
      <choice  next=“http://server:port/Convert.jsp?url=http://www.v-enable.com”>V-
      enable</choice>
      <choice  next=“http://server:port/Convert.jsp?url= http://stocks.yahoo.com”> Yahoo
      stocks</choice>
      <choice  next=“http://server:port/Convert.jsp?url=
      http://www.wirelessknowledge.com”>Visit Wireless Knowledge</choice>
</menu>
```

The main menu may serve as the top-level menu which is heard first when the user initiates a session using the voice browser 110. The Enumerate tag inside the Menu tag automatically builds a list of words from identified by the Choice tags (i.e., “Cnet news”, “V-enable”, “Yahoo stocks”, and “Visit Wireless Knowledge”. When the voice browser 110 visits this menu, The Prompt tag then causes it to prompt the user with following text “Please choose from Cnet news, V-enable, Yahoo stocks, Visit Wireless Knowledge”. Once this menu has been loaded by the voice browser 110, the user may select any of the choices by speaking a command consistent with the technology used by the voice browser 110. For example, the allowable commands may include various “attention” phrases (e.g., “go to” or “select”) followed by the prompt words corresponding to various choices (e.g., “select Cnet news”). After the user has voiced a selection, the voice browser 110 will visit the target URL specified by the relevant attribute associated with the selected choice. In the above conversion, the URL address specified in the onpick attribute of the Option tag is passed as an argument to the Convert.jsp process in the next attribute of the Choice tag. The Convert.jsp process then converts the content specified by the URL address into well-formatted VoiceXML. The format of a set of URL addresses associated with each of the choices defined by the foregoing exemplary main menu are set forth below:
Cnet news→http://MMGC_IPADDRESS:port/Convert.jsp?url=http://cnet.news.com
V-enable→http:// MMGC_IPADDRESS:port/Convert.jsp?url=http://www.v-enable.com
Yahoo stocks→http:// MMGC_IPADDRESS:port/Convert.jsp?url=http://stocks.yahoo.com
Visit Wireless Knowledge→http:// MMGC_IPADDRESS:port/Convert.jsp?url=http://www.wirelessknowledge.com

Referring again to FIG. 7B, any “child” tags of the Select tag are then processed as was described above with respect to the original “root” node of the parse tree and accordingly converted into VoiceXML-based grammatical structures (step 740). Upon completion of the processing of each child of the Select tag, the information associated with the next unprocessed node of the parse tree is retrieved (step 744). To the extent an unprocessed node was identified in step 744 (step 746), the identified node is processed in the manner described above beginning with step 706.

Again directing attention to step 740, an XML-based tag (including, e.g., a Select tag) may be associated with one or more subsidiary “child” tags. Similarly, every XML-based tag (except the tag associated with the root node of a parse tree) is also associated with a parent tag.

The following XML-based notation exemplifies this parent/child relationship:

```
<parent>
  <child1>
    <grandchild1> ..... </grandchild1>
  </child1>
  <child2>
    .....
  </child2>
</parent>
```

In the above example the parent tag is associated with two child tags (i.e., child1 and child2). In addition, tag child1 has a child tag denominated grandchild1. In the case of exemplary WML-based Select operation defined above, the Select tag is the parent of the Option tag and the Option tag is the child of the Select tag. In the corresponding case of the VoiceXML-based Menu operation, the Prompt and Choice tags are children of the Menu tag (and the Menu tag is the parent of both the Prompt and Choice tags).

Various types of information are typically associated with each parent and child tag. For example, list of various types of attributes are commonly associated with certain types of tags. Textual information associated with a given tag may also be encapsulated between the “start” and “end” tagname markings defining a tag structure (e.g., “</tagname>”), with the specific semantics of the tag being dependent upon the type of tag. An accepted structure for a WML-based tag is set forth below:

<tagname attribute1=value attribute2=value . . . >text information </tagname>.

Applying this structure to the case of the exemplary WML-based Option tag described above, it is seen to have the attributes of title and onpick. The title attribute defines the title of the Option tag, while the option attribute specifies the action to be taken if the Option tag is selected. This Option tag also incorporates descriptive text information presented to a user in order to facilitate selection of the Option.

Referring again to FIG. 7B, if an “A” tag is determined to be associated with the element node (step 750), then a new field element and associated grammar are created (step 752) in order to process the tag based upon its attributes. Upon completion of creation of this new field element and associated grammar, the next node in the parse tree is obtained and processing is continued at step 744 in the manner described above. An exemplary conversion of a WML-based A tag into a VoiceXML-based Field tag and associated grammar is set forth below:

WML File with “A” tag

```
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
  <card id=“test” title=“Test”>
    <p>This is a test</p>
    <p>
      <A title=“Go” href=“test.wml”> Hello </A>
    </p>
  </card>
</wml>
```

Here “A” tag has
1. Title=“go”
2. href=“test.wml”

3. Display on screen: Hello [the content between <A . . . ></A>is displayed on screen]

Converted VoiceXML with Field Element

```
<?xml version=“1.0”?>
<vxml>
  <form id=“test”>
  <block>This is a test</block>
  <block>
      <field name=“act”>
        <prompt> Please say Hello or Next </prompt>
    <grammar>
      [ Hello Next ]
    </grammar>
    <filled>
        <if cond=“act == ‘Hello’”>
          <goto next=“test.wml” />
        </if>
    </filled>
      </field>
    </block>
  </card>
</vxml>
```

In the above example, the WML-based textual representation of “Hello” and “Next” are converted into a VoiceXML-based representation pursuant to which they are audibly presented.
If the user utters “Hello” in response, control passes to the same link as was referenced by the WML “A” tag. If instead “Next” is spoken, then VoiceXML processing begins after the “</field>” tag.

If a Template tag is found to be associated with the element node (step 756), the template element is processed by converting it to a VoiceXML-based Link element (step 758). The next node in the parse tree is then obtained and processing is continued at step 744 in the manner described above. An exemplary conversion of the information associated with a WML-based Template tag into a VoiceXML-based Link element is set forth below.

```
Template Tag
<?xml version=“1.0”?>
<!DOCTYPE wml PUBLIC “-//WAPFORUM//DTD WML 1.1//EN”
“http://www.wap/wml_1.1.xml”>
<wml>
  <template>
    <do type=“options” label=“Main”>
    <go href=“next.wml”/>
    </do>
  </template>
  <card>
    <p> hello </p>
  </card>
</wml>
Link Element
<?xml version=“1.0”?>
<vxml>
  <link caching=“safe” next=“next.wml”>
    <grammar>
      [(Main)]
    </grammar>
  </link>
  <form>
    <block> hello </block>
  </form>
</wml>
```

In the event that a WML tag is determined to be associated with the element node, then the WML tag is converted to VoiceXML (step 760).

If the element node does not include any child nodes, then the next node in the parse tree is obtained and processing is continued at step 744 in the manner described above (step 762). If the element node does include child nodes, each child node within the subtree of the parse tree formed by considering the element node to be the root node of the subtree is then processed beginning at step 706 in the manner described above (step 766).

### MULTI-MODE INFORMATION RETRIEVAL SYSTEM

### Overview

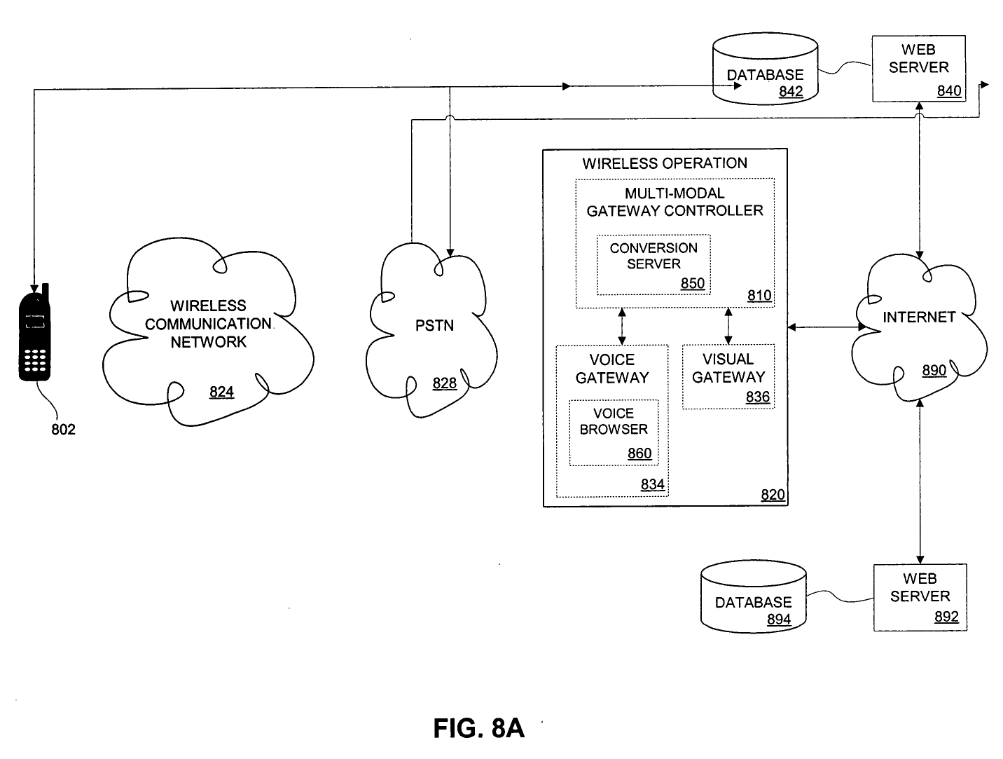

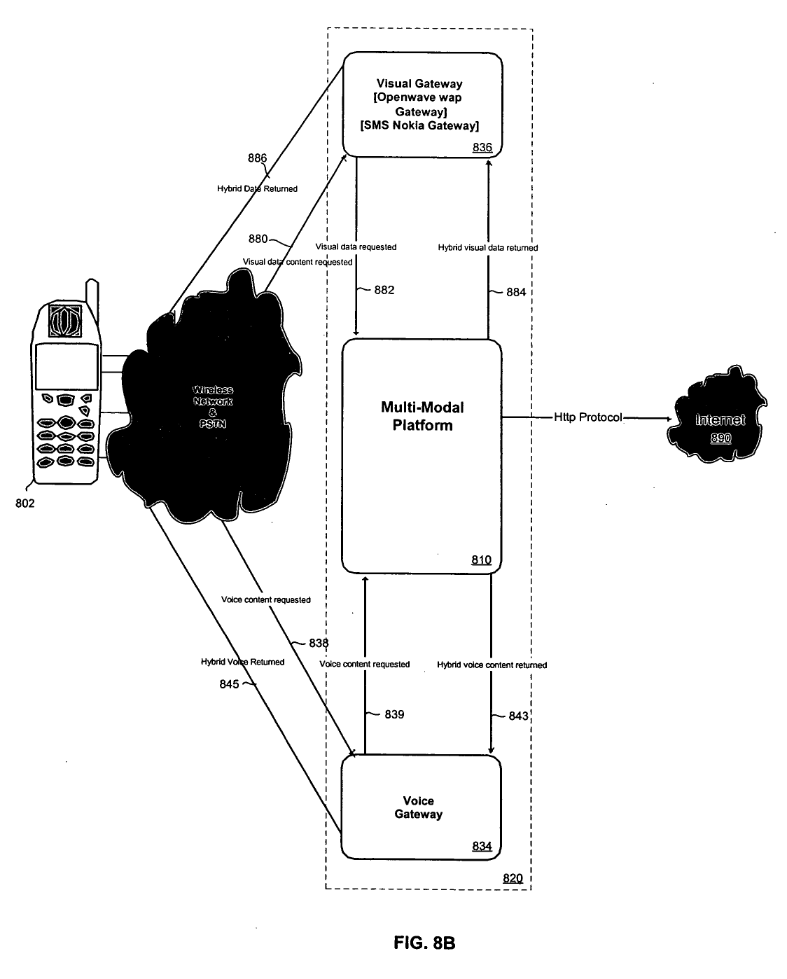

FIGS. 8A and 8B illustratively represent a wireless communication system 800 incorporating a multi-mode gateway controller 810 of the present invention disposed within a wireless operator facility 820. The system 800 includes a telephonic subscriber unit 802, which communicates with the wireless operator facility 820 via a wireless communication network 824 and the public switched telephone network (PSTN) 828. As shown, within the wireless operator facility 820 the multi-mode gateway controller 810 is connected to a voice gateway 834 and a visual gateway 836. During operation of the system 800, a user of the subscriber unit 102 may engage in multi-modal communication with the wireless operator facility 820. This communication may be comprised of a dialogue with the voice gateway 834 based upon content comporting with a known speech mark-up language (e.g., VoiceXML) and, alternately or contemporaneously, the visual display of information served by the visual gateway 836.

The voice gateway 834 initiates, in response to voice content requests 838 issued by the subscriber unit 102, the retrieval of information forming the basis of a dialogue with the user of the subscriber unit 102 from remote information sources. Such remote information sources may comprise, for example, Web servers 840 and one or more databases represented by proprietary database 842. A voice browser 860 within the voice gateway 834 initiates such retrieval by issuing a browsing request 839 to the multi-mode gateway controller 810, which either forwards the request 839 directly to the applicable remote information source or provides it to the conversion server 850. In particular, if the request for content pertains to a remote information source operative in accordance with the protocol applicable to the voice browser 860 (e.g., VoiceXML), then the multi-mode gateway controller 810 issues a browsing request directly to the remote information source of interest. For example, when the request for content 838 pertains to a Web site formatted consistently with the protocol of the voice browser 860, a document file containing such content is requested by the multi-mode gateway controller 810 via the Internet 890 directly from the Web server 840 hosting the Web site of interest. The multi-mode gateway controller 810 then converts this retrieved content into a multi-mode voice/visual document 842 in the manner described below. The voice gateway 834 then conveys the corresponding multi-mode voice/visual content 844 to the subscriber unit 802. On the other hand, when a voice content request 838 issued by the subscriber unit 802 identifies a Web site formatted inconsistently with the voice browser 860, the conversion server 850 retrieves content from the Web server 840 hosting the Web site of interest and converts this content into a document file compliant with the protocol of the voice browser 860. This converted document file is then further converted by the multi-mode gateway controller into a multi-mode voice/visual document file 843 in the manner described below. The multi-mode voice/visual document file 843 is then provided to the voice browser 860, which communicates multi-mode voice content 845 to the subscriber unit 102.

Similarly, when a request for content identifies a proprietary database 842, the voice browser 860 issues a corresponding browsing request to the conversion server 850. In response, the conversion server 850 retrieves content from the proprietary database 842 and converts this content into a multi-mode voice/visual document file 843 compliant with the protocol of the voice browser 860. The document file 843 is then provided to the voice browser 860, and is used as the basis for communicating multi-mode voice content 845 to the subscriber unit 102.

The visual gateway 836 initiates, in response to visual content requests 880 issued by the subscriber unit 802, the retrieval of visual-based information from remote information sources. In the exemplary embodiment such information sources may comprise, for example, a Web servers 890 and a proprietary database 892 disposed to serve visual-based content. The visual gateway 836 initiates such retrieval by issuing a browsing request 882 to the multi-mode gateway controller 810, which forwards the request 882 directly to the applicable remote information source. In response, the multi-mode gateway controller 810 receives a document file containing such content from the remote information source via the Internet 890. This multi-mode gateway controller 810 then converts this retrieved content into a multi-mode visual/voice document 884 in the manner described below. The visual gateway 836 then conveys the corresponding multi-mode visual/voice content 886 to the subscriber unit 802.

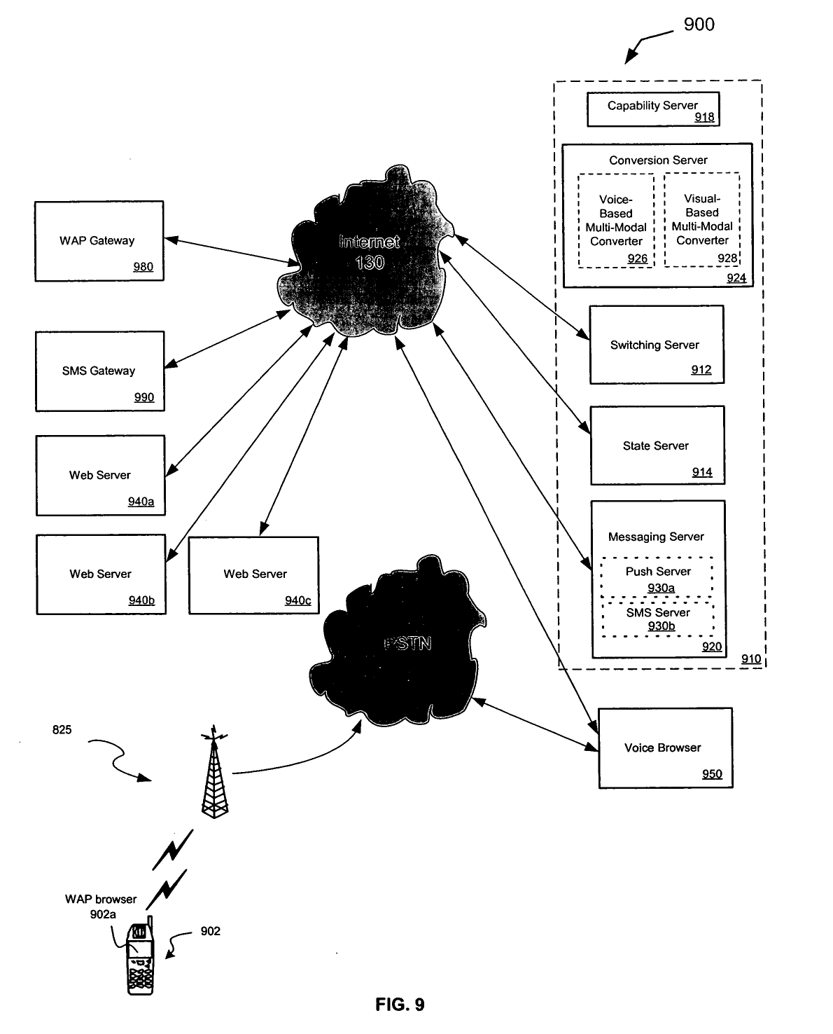

FIG. 9 provides an alternate block diagrammatic representation of a multi-modal communication system 900 of the present invention. As shown, the system 900 includes a multi-mode gateway controller 910 incorporating a switching server 912, a state server 914, a device capability server 918, a messaging server 920 and a conversion server 924. As shown, the messaging server 920 includes a push server 930a and SMS server 930b, and the conversion server 924 includes a voice-based multi-modal converter 926 and a visual-based multi-modal converter 928. The system 900 also includes telephonic subscriber unit 902 with voice capabilities, display capabilities, messaging capabilities and/or WAP browser capability in communication with a voice browser 950. As shown, the system 900 further includes a WAP gateway 980 and/or a SMS gateway 990. As is described below, the subscriber unit 902 receives multi-mode voice/visual or visual/voice content via a wireless network 925 generated by the multi-mode gateway controller 910 on the basis of information provided by a remote information source such as a Web server 940 or proprietary database (not shown). In particular, multi-mode voice/visual content generated by the gateway controller 910 may be received by the subscriber unit 902 through the voice browser 950, while multi-mode visual/voice content generated by the gateway controller 910 may be received by the subscriber unit 902 through the WAP gateway 980 or SMS gateway 990.

In the exemplary embodiment the voice browser 950 executes dialogues with a user of the subscriber unit 902 in a voice mode on the basis of multi-mode voice/visual document files provided by the multi-mode gateway controller 910. As described below, these multi-mode document files are retrieved by the multi-mode gateway controller 910 from remote information sources and contain proprietary tags not defined within the applicable speech mark-up language (e.g., VoiceXML). Upon being interpreted by the multi-mode gateway controller 910, these tags function to enable the underlying content to be delivered in a multi-modal fashion. During operation of the multi-mode gateway controller 910, a set of operations corresponding to the interpreted proprietary tags are performed by its constituent components (switching server 912, state server 914 and device capability server 918) in the manner described below. Such operations may, for example, invoke the switching server 912 and the state server 914 in order to cause the delivery context to be switched from voice to visual mode. As is illustrated by the examples below, the type of proprietary tag employed may result in such information delivery either being contemporaneously visual-based and voice-based, or alternately visual-based and voice-based. The retrieved multi-mode document files are also provided to the voice browser 950, which uses them as the basis for communication with the subscriber unit 802 in accordance with the applicable voice-based protocol.

In the embodiment of FIG. 9, the messaging server 920 is responsible for transmitting visual content in the appropriate form to the subscriber unit 910. As is discussed below, the switching server 912 invokes the device capability server 918 in order to ascertain whether the subscriber unit 902 is capable of receiving SMS, WML, xHTML, cHTML, SALT, X+V content, thereby enabling selection of an appropriate visual-based protocol for information transmission. Upon requesting the messaging server 920 to send such visual content to the subscriber unit 920 in accordance with the selected protocol, the switching server 912 disconnects the current voice session. For example, if the device capability server 918 signals that the subscriber unit 902 is capable of receiving WML/xHTML content, then the push server 930a is instructed by the switching server 912 to push the content to the subscriber unit 902 via WAP gateway 980. Otherwise, if the device capability server 918 signals that the subscriber unit 902 is capable of receiving SMS, then the SMS server 930b is used to send SMS messages to the subscriber unit 902 via the SMS gateway 990. The successful delivery of this visual content to the subscriber unit 902 confirms that the information delivery context has been switched from a voice-based mode to a visual-based mode.

In the exemplary embodiment a WAP browser 902a within the subscriber unit 902 visually interacts with a user of the subscriber unit 902 on the basis of multi-mode voice/visual document files provided by the multi-mode gateway controller 910. These multi-mode document files are retrieved by the multi-mode gateway controller 910 from remote information sources and contain proprietary tags not defined by the WAP specification. Upon being interpreted by the multi-mode gateway controller 910, these tags function to enable the underlying content to be delivered in a multi-modal fashion. During operation of the multi-mode gateway controller 910, a set of operations corresponding to the interpreted proprietary tags are performed by its constituent components (i.e., the switching server 912, state server 914 and device capability server 918) in the manner described below. Such operations may, for example, invoke the switching server 912 and the state server 914 in order to cause the delivery context to be switched from visual to voice mode. As is illustrated by the examples below, the type of proprietary tag employed may result in such information delivery either being contemporaneously visual-based and voice-based, or alternately visual-based and voice-based. The retrieved multi-mode document files are also provided to the WAP gateway 980, which use them as the basis for communication with the WAP browser 902a in accordance with the applicable visual-based protocol. Communication of multi-mode content to the subscriber unit 902 via the SMS gateway 990 may be effected in a substantially similar fashion.

The multi-mode multi-modal content contemplated by the present invention may comprise the integration of existing forms of visual content (e.g. WML, xHTML, cHTML, X+V, SALT, plain text, iMode) content and existing forms of voice content (e.g. VoiceXML, SALT) content. The user of the subscriber unit 902 has the option of either listening to the delivered content over a voice channel or of viewing such content over a data channel (e.g., WAP, SMS). As is described in further detail below, while browsing a source of visual content a user of the subscriber unit 902 may say “listen” at any time in order to switch to a voice-based delivery mode. In this scenario the WAP browser 902a switches the delivery context to voice using the switching server 912, which permits the user to communicate on the basis of the same content source in voice mode via the voice browser 950. Similarly, while listening to a source of voice content, the user may say “see” at any time and the voice browser 950 will switch the context to visual using the switching server 912. The user then communicates with the same content source in a visual mode by way of the WAP browser 902a. In addition, the present invention permits enhancement of an active voice-based communication session by enabling the contemporaneous delivery of visual information over a data channel established with the subscriber unit 902. For example, consider the case in which a user of the subscriber unit 902 is listening to electronic mail messages stored on a remote information source via the voice browser 950. In this case the multi-mode gateway controller 910 could be configured to sequentially accord each message an identifying number and “push” introductory or “header” portions of such messages onto a display screen of the subscriber unit 902. This permits a user to state the identifying number of the email corresponding to a displayed message header of interest, which causes the content of such message to be played to the user via the voice browser 950.

### Voice Mode Tag Syntax

As mentioned above, the multi-mode gateway controller 910 operates to interpret various proprietary tags interspersed within the content retrieved from remote information sources so as to enable content which would otherwise be delivered exclusively in voice form via the voice browser 950 to instead be delivered in a multi-modal fashion. The examples below describe a number of such proprietary tags and the corresponding instruction syntax within a particular voice markup language (i.e., VoiceXML).

Switch

The <switch>tag is intended to enable a user to switch from a voice-based delivery mode to a visual delivery mode. Such switching comprises an integral part of the unique provision of multi-modal access to information contemplated by the present invention. Each <switch>tag included within a within a VoiceXML document contains a uniform resource locator (URL) of the location of the source content to be delivered to the requesting subscriber unit upon switching of the delivery mode from voice mode to visual mode. In the exemplary embodiment the <switch>tag is not processed by the voice browser 950, but is instead interpreted by the multi-mode gateway controller 910. This interpretation process will typically involve internally calling a JSP or servlet (hereinafter referred to as SwitchContextToVoice.jsp) in order to process the <switch>tag in the manner discussed below.

The syntax for an exemplary implementation of the <switch>tag is set forth immediately below. In addition, Table I provides a description of the attributes of the <switch>tag, while Example I exemplifies its use.

Syntax

<switch url=“wmlfile|vxmlfile|xHTML|cHTML|HDMLfile|iMode|plaintext file” text=“any text” title=“title”/>

TABLE I

| Attribute | Description |
|---|---|
| url | The URL address of the visual based content (e.g., |
| | WML, xHTML, HDML, text) or the voice based content |
| | that is to be seen or heard upon switching content |
| | delivery modes. In the exemplary embodiment either a |
| | url attribute or a text attribute should always be present. |
| Text | Permits text to be sent to the subscriber unit |
| Title | The title of the link |

### EXAMPLE I

<if cond=“show”>

<switch url=“http://wap.cnet.com/news.wml “title=“news”/>

</if>

The multi-mode gateway controller will translate the switch in the following way:

<if cond=“show”>

<goto next=“http://www.v-enable.com/SwitchContextToVoice.jsp?phoneNo=session.telephone.ani& url=http://wap.cnet.com/news.wml&title=news”/>

</if>

As is described in general terms immediately below, switching from voice mode to visual mode may be achieved by terminating the current voice call and automatically initiating a data connection in order to begin the visual-based communication session. In addition, source code pertaining to an exemplary method (i.e., processSwitch) of processing the <switch>tag is included within Appendix E.

1. The SwitchContextToVoice.jsp initiates a client request to switching server 912 in order to switch the context from voice to visual.

2. The SwitchContextToVisual.jsp invokes the device capability server 918 in order to determine the capabilities of the subscriber unit 902. In the exemplary embodiment the subscriber unit 902 must be registered with the multi-mode gateway controller 910 prior to being permitted to access its services. During this registration process various information concerning the capabilities of the subscriber unit 902 is stored within the multi-mode gateway controller, such information generally including whether or not the subscriber unit 902 is capable of accepting a push message or an SMS message (i.e., whether the subscriber unit 902 is WAP-enabled or SMS-enabled). An exemplary process for ascertaining whether a given subscriber unit is WAP-enabled or SMS-enabled is described below. It is observed that substantially all WAP-enabled subscriber units are capable of accepting push messages, to which may be attached a URL link. Similarly, substantially all SMS-enabled subscriber units are capable of accept SMS messages, to which may be attached a call back number.

3. The SwitchContextToVisual.jsp uses the session.telephone.ani to obtain details relating to the user of the subscriber unit 902. The session.telephone.ani, which is also the phone number of the subscriber unit 902, is used as a key to identify the applicable user.

4. If the subscriber unit 802 is WAP-enabled and thus capable of accepting push messages, then SwitchContextToVisual.jsp requests the messaging server 920 to instruct the push server 930a to send a push message to the subscriber unit 902. The push message contains a URL link to another JSP or servlet, hereinafter termed the “multi-modeVisual.jsp.” If the uri attribute described above in Table I is present in the <switch>tag, then the multi-modeVisual.jsp checks to determine whether this URL link is of the appropriate format (i.e., WML, xHTML etc) so as to be capable of being displayed by the WAP browser 902a. The content specified by the URL link in the <switch>tag is then converted into multi-modal WML/xHTML, and is then pushed to the WAP browser 902a. More particularly, the SwitchContextToVisual.jsp effects this push operation using another JSP or servlet, hereinafter termed “push.jsp”, to deliver this content to the WAP browser 902a in accordance with the push protocol. On the other hand, if the text attribute described above in Table I is present in the <switch>tag, then multi-modeVisual.jsp converts the text present within the text attribute into a multi-modal WML/xHTML file suitable for viewing by the WAP browser 902a.

5. In the case where the subscriber unit 802 is SMS-based, then SwitchContextToVisual.jsp converts the URL link (if any) in the <switch>tag into a plain text message. SwitchContextToVisual.jsp then requests the messaging server 920 to instruct the SMS server 930b to send the plain text to the subscriber unit 902. The SMS server 930b also attaches a call back number of the voice browser 950 in order to permit the user to listen to the content of the plain text message. If the text attribute is present, then the inline text is directly pushed to the screen of the subscriber unit 902 as an SMS message.

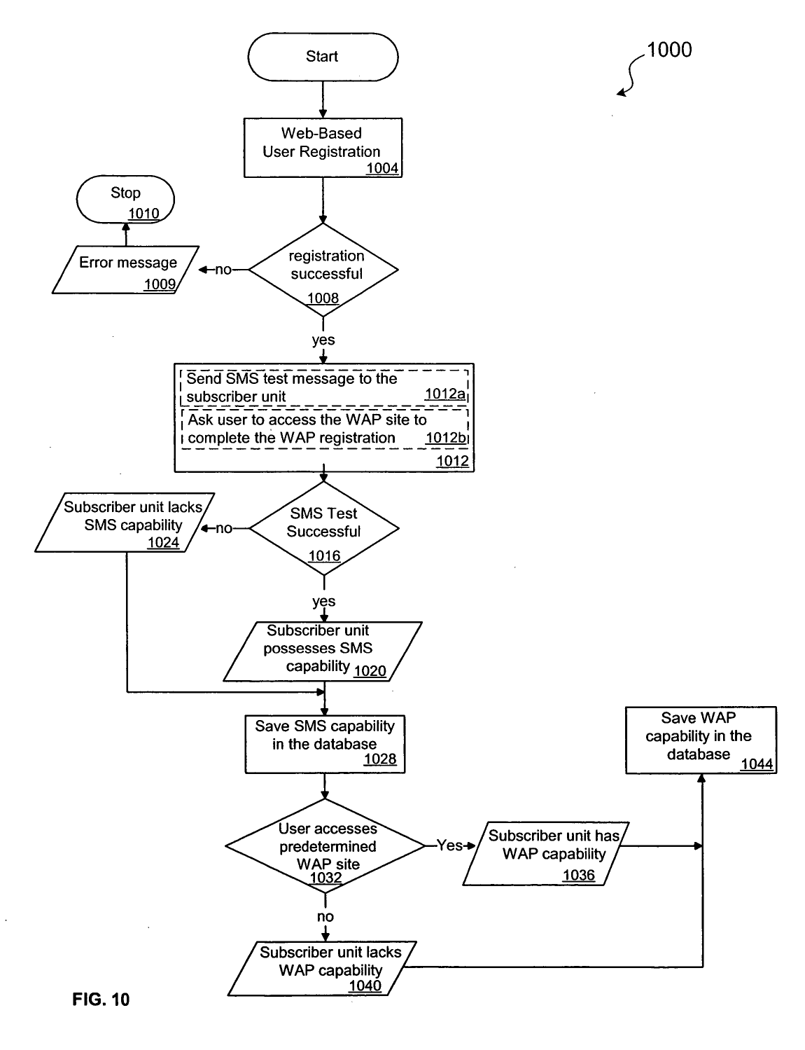

Turning now to FIG. 10, a flow chart is provided of an exemplary two-step registration process 1000 for determining whether a given subscriber unit is configured with WAP-based and/or SMS-based communication capability. In an initial step 1004, the user of the subscriber unit 902 first registers at a predetermined Web site (e.g., www.v-enable.org). As part of this Web registration process, the registering user provides the phone number of the subscriber unit 902 which will be used to access the multi-mode gateway controller 910. If this Web registration process is successfully completed (step 1008a), an SMS-based “test” message is sent to the user's subscriber unit 902 by the SMS server 930b (step 1012); otherwise, the predetermined Web site provides the with an error message (step 1009) and processing terminates (1010). In this regard the SMS server 930b uses the SMS-based APIs provided by the service provider (e.g., Cingular, Nextel, Sprint) with which the subscriber unit 902 is registered to send the SMS-based test message. If the applicable SMS function returns a successful result (step 1016), then it has been determined that the subscriber unit is capable of receiving SMS messages (step 1020). Otherwise, it is concluded that the subscriber unit 902 does not possess SMS capability (step 1024). The results of this determination are then stored within a user capability database (not shown) within the multi-mode gateway controller 910 (step 1028).

Referring again to FIG. 10, upon successful completion of the Web registration process (step 1008), the multi-mode gateway controller 910 then informs the user to attempt to access a predetermined WAP-based Web site (step 1012b). If the user successfully accesses the predetermined WAP-based site (step 1032), then the subscriber unit 902 is identified as being WAP-capable (step 1036). If the subscriber unit 902 is not configured with WAP capability, then it will be unable to access the predetermined WAP site and hence will be deemed to lack such WAP capability (step 1040). In addition, information relating to whether or not the subscriber unit 902 possesses WAP capability is stored within the user capability database (not shown) maintained by the multi-mode gateway controller 910 (step 1044). During subsequent operation of the multi-mode gateway controller 910, this database is accessed in order to ascertain whether the subscriber unit is configured with WAP or SMS capabilities.

Show

The <show>tag leverages the dual channel capability of 2.0/2.5/3.0G subscriber units, which generally permit contemporaneously active SMS and voice sessions. When the <show>tag is executed, the current voice session remains active. In contrast, the <switch>tag disconnects the voice session after beginning the data session. The multi-mode gateway controller 910 provides the necessary synchronization and state management needed to coordinate between the voice and data channel active at the same time. Specifically, upon being invoked in connection with execution of the <show>tag, the SMS server 930b provides the necessary synchronization between the concurrently active voice and visual communication sessions. The SMS server 930b effects such synchronization by first delivering the applicable SMS message via the SMS gateway 990. Upon successful delivery of such SMS message to the subscriber unit 902, the SMS server 930b then causes the voice source specified in the next attribute of the <show>tag to be played.

The syntax for an exemplary implementation of the <show>tag is set forth immediately below. In addition, Table II provides a description of the attributes of the <show>tag, while Example II exemplifies its use.

Syntax

<show text=”“url=”“next=”VOICE_URL”>

TABLE II

| Attribute | Description |
|---|---|
| text | The inline text message desired to send to the subscriber unit. |
| url | The link which is desired to be seen on the screen of the |
| | subscriber unit. In the exemplary embodiment either a |
| | url attribute or a text attribute should always be present. |
| next | The URL at which the control flow will begin once data has |
| | been sent to the subscriber unit. |

### EXAMPLE II

The example below demonstrates a multi-modal electronic mail application utilizing a subscriber unit 902 configured with conventional second generation (“2G”) voice and data capabilities. Within the multi-mode gateway controller 910, a showtestemail.vxml routine uses the <show>tag to send numbered electronic mail (“email”) headers to the subscriber unit 902 for display to the user. After such headers have been sent, the voice session is redirected to an email.vxml file. In this regard the email.vxml file contains the value of the next attribute in the <show>tag, and prompts the user to state the number of the email header to which the user desires to listen. As is indicated below, the email.vxml then plays the content of the email requested by the user. In this way the <show>tag permits a subscriber unit 902 possessing only conventional 2G capabilities to have simultaneous access to voice and visual content using SMS capabilities.

File: showtestemail.vxml

```
<?xml version=“1.0”?>
<vxml version=“1.0”>
<form id =“showtest”>
  <block>
    <prompt>
      Email. This demonstrates the show tag. </prompt>
    <show text =“1:Hello 2:Happy New Year 3:Meeting postponed”
      next =“http://www.v-enable.org/appl/email.vxml”/>
  </block>
</form>
</vxml>
```

The multi-mode gateway controller 910 will translate the above showtestemail.vxml as:

```
<?xml version=“1.0”?>
<vxml version=“1.0”>
<form id =“showtest”>
  <block>
    <prompt>
      Email. This demonstrates the show tag.
    </prompt>
    <goto next=”http://www.v-enable.org/ShowText.jsp?
      phoneNo=session.telephone.ani&
      SMSText=1:Hello 2:Happy New Year 3:Meeting postponed&
      next =http://www.v-enable.org/appl/email.vxml/>
  </block>
</form>
</vxml>
File: email.vxml
<?xml version=“1.0”?>
<vxml version=“1.0”>
<form id =“address”>
<property name =“bargein” value=“false”/>
  <field name=“sel”>
    <prompt bargein=“false”>
    Please say the number of the email header you want to listen.
    </prompt>
    <grammar>
      [one two three]
    </grammar>
    <noinput>
      <prompt> I am sorry I didn't hear anything </prompt>
      <reprompt/>
    </noinput>
  </field>
  <filled>
    <if cond=“sel==‘one’”>
    <goto next=http://www.v-enable.org/email/one.vxml/>
    <elseif cond=“sel==‘two’”/>
    <goto next=http://www.v-enable.org/email/two.vxml/>
    <elseif cond=“sel==‘three’”/>
    <goto next=http://www.v-enable.org/email/three.vxml/>
    </if>
  </filled>
</form>
</vxml>
```

Referring to the exemplary code of Example II above, a ShowText.jsp is seen to initiate a client request to the messaging server 920. In turn, the messaging server 920 passes the request to the SMS server 930b, which sends an SMS message to the subscriber unit 902 using its phone number obtained during the registration process described above. The SMS server 930b may use two different approaches for sending SMS messages to the subscriber unit 902. In one approach the SMS server 930b may invoke the Simple Mail Transfer Protocol (i.e., the SMTP protocol), which is the protocol employed in connection with the transmission of electronic mail via the Internet. In this case the SMTP protocol is used to send the SMS message as an email message to the subscriber unit 902. The email address for the subscriber 902 is obtained from the wireless service provider (e.g., SprintPCS, Cingular) with which the subscriber unit 902 is registered. For example, a telephone number (xxxyyyzzzz) for the subscriber unit 902 issued by the applicable service provider (e.g., SprintPCS) may have an associated email address of xxxyyyzzzz@messaging.sprintpcs.com. If so, any SMS-based email messages sent to the address xxxyyyzzzz@messaging.sprintpcs.com will be delivered to the subscriber unit 902 via the applicable messaging gateway (i.e., the Short Message Service Center or “SMSC”) of the service provider.

An alternate approach used by the SMS server 930b in communicating with the subscriber unit 902 utilizes messages consistent with the Short Message Peer to Peer protocol (i.e., the SMPP protocol). The SMPP protocol is an industry standard protocol defining the messaging link between the SMSC of the applicable service provider and external entities such as the SMS server 930b. The SMPP protocol enables a greater degree of control to be exercised over the messaging process. For example, queries may be made as to the status of any messages sent, and appropriate actions taken in the event delivery failure or the like is detected (e.g., message retransmission). Once the message has been successfully received by the subscriber unit 902, the SMS server 930b directs the current active voice call to play the VoiceXML file specified in the next attribute of the <show>tag. In Example II above the specified VoiceXML file corresponds to email.vxml.

Appendix E includes source code for an exemplary method (i.e., processShow) of processing a <show>tag.

### Visual Mode Tag Syntax

As mentioned above, the multi-mode gateway controller 910 operates to interpret various proprietary tags interspersed within the content retrieved from remote information sources so as to enable content which would otherwise be delivered exclusively in visual form via the WAP gateway 980 and WAP browser 902a to instead be delivered in a multi-modal fashion. The examples below describe a number of such proprietary tags and the corresponding instruction syntax within a particular visual markup language (i.e., WML, xHTML etc.).

Switch

The <switch>tag is intended to enable a user to switch from a visual-based delivery mode to a voice-based delivery mode. Each <switch>tag contains a uniform resource locator (URL) of the location of the source content to be delivered to the requesting subscriber unit upon switching of the delivery mode from visual mode to voice mode. In the exemplary embodiment the <switch>tag is not processed by the WAP gateway 980 or WAP browser 902a, but is instead interpreted by the multi-mode gateway controller 910. This interpretation process will typically involve internally calling a JSP or servlet (hereinafter referred to as SwitchContextToVoice.jsp) in order to process the <switch>tag in the manner discussed below.

The syntax for an exemplary implementation of the <switch>tag is set forth immediately below. In addition, Table III provides a description of the attributes of the <switch>tag, while Example III exemplifies its use.

Syntax

<switch url=“wmlfile|vxmlfile|xHTML|cHTML‥HDMLfile|iMode|plaintext|audiofiles” text=“any text”/>

TABLE III

| Attribute | Description |
|---|---|
| url | The URL address of any visual based content (e.g., WML, |
| | xHTML, cHTML, HDML etc.), or of any voice based |
| | content (e.g., VoiceXML), to which it is desired to listen. |
| | The URL could also point to a source of plain text or of |
| | alternate audio formats. Any incompatible voice or |
| | non-voice formats are automatically converted into a |
| | valid voice format (e.g., |
| | VoiceXML).. In the exemplary embodiment either a url |
| | attribute or a text attribute should always be present. |
| Text | Permits inline text to be heard over the applicable voice |
| | channel. |

### EXAMPLE III

In the context of a visual markup language such as WML, the <switch>tag could be utilized as follows:

```
<wml>
  <card title=“News Service”>
    <p>
      Cnet news
    </p>
    <do type=“options” label=“Listen”>
      <switch href =http://wap.cnet.com/news.wml/>
    </do>
  </card>
</wml>
Similar content in xHTML would be as follows:
<?xml version=“1.0”?>
<!DOCTYPE html PUBLIC“-//WAPFORUM//DTD XHTML Mobile 1.0//
EN”
“http://www.wapforum.org/DTD/xhtmlmobile10.dtd”>
<html xmlns=“http://www.w3.org/1999/xhtml” >
  <head>
    <title>News Service</title>
  </head>
  <body>
    <p>Cnet News<br/>
    <switch href =http://wap.cnet.com/news.wml/>
    </p>
  </body>
</html>
```

In the exemplary code segment above, a listen button has been provided which permits the user to listen to the content of http://wap.cnet.com/news.wml. The multi-mode gateway controller 910 will translate the <switch>tag in the manner indicated by the following example. As a result of this translation, a user is able to switch the information delivery context to voice mode by manually selecting or pressing such a listen button displayed upon the screen of the subscriber unit 902.

In WML:

```
<wml>
  <card title=“News Service”>
    <p>
      Cnet news
    </p>
    <do type=“options” label=“Listen”>
      <go
      href =http:// MMGC_IPADDRESS:port/
      SwitchContextToVoice.jsp?
      url=http://wap.cnet.com/news.wml”/>
    </do>
  </card>
</wml>
```

In xHTML:

```
<?xml version=“1.0”?>
<!DOCTYPE html PUBLIC “-//WAPFORUM//DTD XHTML Mobile
1.0//EN”
“http://www.wapforum.org/DTD/xhtmlmobile10.dtd”>
<html xmlns=“http://www.w3.org/1999/xhtml” >
  <head>
    <title>News Service</title>
  </head>
  <body>
    <p>Cnet News<br/>
    <a
    href =http:// MMGC_IPADDRESS:port/SwitchContextToVoice.jsp?
    url=http://wap.cnet.com/news.wml”/>
    </p>
  </body>
</html>
```

Set forth below is an exemplary sequence of actions involved in switching the information delivery context from voice mode to visual mode. As is indicated, the method contemplates invocation of the SwitchContextToVoice.jsp. In addition, Appendix F and Appendix G include the source code for exemplary WML and xHTML routines, respectively, configured to process <switch>tags placed within voice-based files.

Voice Mode to Visual Mode Switching

1. User selects or presses the listen button displayed upon the screen of the subscriber unit 902.

2. In response to selection of the listen button, the SwitchContextToVoice.jsp initiates a client request to switching server 912 in order to switch the context from visual to voice.

3. The user passes the WML link (e.g., http://www.abc.com/xyz.wml) to which it is desired to listen to the switching server 912.

4. The switching server 912 uses the state server 914 to save the above link as the “state” of the user.

5. The switching server 912 then uses the WTAI protocol to initiate a standard voice call with the subscriber unit 902, and disconnects the current WAP session.

6. A connection is established with the subscriber unit 902 via the voice browser 950.

7. The voice browser calls a 950 calls a JSP or servlet, hereinafter termed Startvxml.jsp, that is operative to check or otherwise determine the type of content to which the user desires to listen. The Startvxml.jsp then obtains the “state” of the user (i.e., the URL link to the content source to which the user desires to listen) from the state server 914.

8. Startvxml.jsp determines whether the desired URL link is of a format (e.g., VoiceXML) compatible with the voice browser 950. If so, then the voice browser 950 plays the content of the link. Else if the link is associated with a format (e.g. WML, xHTML, HDML, iMode) incompatible with the nominal format of the voice browser 950 (e.g., VoiceXML), then Startvxml.jsp fetches the content of URL link and converts it into valid VoiceXML source. The voice browser 950 then plays the converted VoiceXML source. If the link is associated with a file of a compatible audio format, then this file is played directly by the voice browser 950 plays that audio file. If the text attribute is present, then the inline text is encapsulated within a valid VoiceXML file and the voice browser 950 plays the inline text as well.

Listen

The <listen>tag leverages the dual channel capability of subscriber units compliant with 2.5G and 3G standards, which permit initiation of a voice session while a data session remains active. In particular, processing of the <listen>tag results in the current data session remaining active while a voice session is initiated. This is effected through execution of a UPL specified in the url attribute of the <listen>tag (see exemplary syntax below). If the format of such URL is inconsistent with that of the voice browser 950, then it is converted by the multi-mode gateway controller 910 into an appropriate voice form in the manner described in the above-referenced copending patent applications. The multi-mode gateway controller 910 provides the necessary synchronization and state management needed to coordinate between contemporaneously active voice and data channels.

The syntax for an exemplary implementation of the <listen>tag is set forth immediately below. In addition, Table IV provides a description of the attributes of the <show>tag.

Syntax

<listen text=”“url=”VOICE_URL “next=“VISUAL_URL”>

TABLE IV

| Attribute | Description |
|---|---|
| Ext | The inline text message to which it is desired to listen. |
| url | The link to the content source to which it is desired to listen. |
| | In the exemplary embodiment either a url attribute or a |
| | text attribute should always be present. |
| next | This optional attribute corresponds to the URL to which |
| | control will pass once the content at the location |
| | specified by the url attribute has been played. If next |
| | is not present, the flow of control depends on the |
| | VOICE_URL. |

Automatic Conversion of Visual/Voice Content into Multi-modal Content

As has been discussed above, the multi-mode gateway controller 910 processes the above-identified proprietary tags by translating them into corresponding operations consistent with the protocols of existing visual/voice markup language. In this way the multi-mode gateway controller 910 allows developers to compose unique multi-modal applications through incorporation of these tags into existing content or through creation of new content.

In accordance with another aspect of the invention, existing forms of conventional source content may be automatically converted by the multi-mode gateway controller 910 into multi-modal content upon being retrieved from remote information sources. The user of the subscriber unit 902 will generally be capable of instructing the multi-mode gateway controller 910 to invoke or disengage this automatic conversion process in connection with a particular communication session.

As is described below, automatic conversion of voice content formatted consistently with existing protocols (e.g., VoiceXML) may be automatically converted into multi-modal content through appropriate placement of <show>grammar within the original voice-based file. The presence of <show>grammar permits the user of a subscriber unit to say “show” at any time, which causes the multi-mode gateway controller 910 to switch the information delivery context from a voice-based mode to a visual-based mode. Source code operative to automatically place <show>grammar within a voice-based file is included in Appendix E. In addition, an example of the results of such an automatic conversion process is set forth below:

```
<vxml>
  <link caching =”safe”
  next =”<http:// MMGC_IPADDRESS:port/SwitchContextToVoice.jsp?
  phoneNo=session.telephone.ani&url=currentUrl&
  title=NetAlert“/>
    <grammar>
      [ show ]
    </grammar>
  </link>
  <form id=”formid”>
  </form>
</vxml>
```

In the exemplary embodiment the user may disable the automatic conversion of voice-based content into multi-modal content through execution of the following:

<vxml multi-modal=“false”>

Such execution will direct the multi-mode gateway controller 910 to refrain from converting the specified content into multi-modal form. The exemplary default value of the above multi-modal expression is “true”. It is noted that execution of this automatic multi-modal conversion process and the <switch>operation are generally mutually exclusive. That is, if the <switch>tag is already present in the voice-based source content, then the multi-mode gateway controller 910 will not perform the automatic multi-modal conversion process.

In the case of visual-based markup languages (e.g., WML, xHTML), any source content accessed through the multi-mode gateway controller 910 is automatically converted into multi-modal content through insertion of a listen button at appropriate locations. A user of the subscriber unit 902 may press such a listen button at any time in order to cause the multi-mode gateway controller 910 to switch the information delivery context from visually-based to voice-based. At this point the current visual content is converted by the visual-based multi-modal converter 928 within the conversion server 924 into corresponding multi-modal content containing a voice-based component compatible with the applicable voice-based protocol. This voice-based component is then executed by the voice browser 950.

Consider now the following visual-based application, which lacks a listen button contemplated by the present invention:

In WML:

```
<wml>
  <head>
    <meta http-equiv=“Cache-Control” content=“must-revalidate”/>
    <meta http-equiv=“Expires” content=“Tue, 01 Jan 1980 1:00:00
    GMT”/>
    <meta http-equiv=“Cache-Control” content=“max-age=0”/>
  </head>
  <card title=“Hello world”>
    <p mode=“wrap”>
      Hello world!!
    </p>
  </card>
</wml>
```

In xHTML:

```
<?xml version=“1.0”?>
<!DOCTYPE html PUBLIC “-//WAPFORUM//DTD XHTML Mobile
1.0//EN”
“http://www.wapforum.org/DTD/xhtmlmobile10.dtd”>
<html xmlns=“http://www.w3.org/1999/xhtml” >
  <head>
    <title>Hello World</title>
  </head>
  <body>
    <p>Hello World</p>
  </body>
</html>
```

When the above application is accessed via the multi-mode gateway controller 910 and the automatic conversion process has been enabled, the gateway controller 910 automatically generates multi-modal visual-based content through appropriate insertion of a <listen>tag in the manner illustrated below:

In WML:

```
<wml>
  <head>
    <meta http-equiv=“Cache-Control” content=“must-revalidate”/>
    <meta http-equiv=“Expires” content=“Tue, 01 Jan 1980 1:00:00
    GMT”/>
    <meta http-equiv=“Cache-Control” content=“max-age=0”/>
  </head>
  <template>
    <do type=“options” label=“Listen”>
      <go href=“http://
      MMGC_IPADDRESS:port/SwitchContextToVoice.jsp?
      url=currentWML/>
    </do>
  </template>
  <card title=“Hello world”>
    <p mode=“wrap”>
      Hello world!!
    </p>
  </card>
</wml>
```

in xHTML:

```
<?xml version=“1.0”?>
<!DOCTYPE html PUBLIC “-//WAPFORUM//DTD XHTML Mobile
1.0//EN”
“http://www.wapforum.org/DTD/xhtmlmobile10.dtd”>
<html xmlns=“http://www.w3.org/1999/xhtml” >
  <head>
    <title>Hello World</title>
  </head>
  <body>
    <p>Hello World<br/>
    <a href=“http://
    MMGC_IPADDRESS:port/scripts/SwitchContextToVoice.Script?
    url=currentxHTML”>Listen</a>
    </p>
  </body>
</html>
```

In the above example the phrase “Hello World” is displayed upon the screen of the subscriber unit 902. The user of the subscriber unit 902 may also press the displayed listen button at any time in order to listen to the text “Hello World”. In such event the SwitchContextToVoice.jsp invokes the visual-based multi-modal converter 928 to convert the current visual-based content into voice-based content, and switches the information delivery context to voice mode. Appendix F and Appendix G include the source code for exemplary WML and xHTML routines, respectively, each of which is configured to automatically place “listen” keys within visual-based content files.

The user may disable the automatic conversion of visual-based content into multi-modal content as follows:

<wml multi-modal=“false”>or <html multi-modal=“false”>

This operation directs the multi-mode gateway controller 910 to refrain from converting the specified content into a multi-modal format (i.e., the default value of the multi-modal conversion process is “true”). It is noted that execution of this automatic multi-modal conversion process and the <switch>operation are generally mutually exclusive. That is, if the <switch>tag is already present in the visual-based source content, then the multi-mode gateway controller 910 will not perform the automatic multi-modal conversion process.

### Page-Based & Link-Based Switching Methods

The multi-mode gateway controller 910 may be configured to support both page-based and link-based switching between voice-based and visual-based information delivery modes. Page-based switching permits the information delivery mode to be switched with respect to a particular page of a content file being perused. In contrast, link-based switching is employed when it is desired that content associated with a particular menu item or link within a content file be sent using a different delivery mode (e.g., visual) than is currently active (e.g., voice). In this case the information delivery mode is switched in connection with receipt of all content associated with the selected menu item or link Examples IV and V below illustrate the operation of the multi-mode gateway controller 910 in supporting various page-based and link-based switching methods of the present invention.

Page-Based Switching

During operation in this mode, the state of each communication session handled by the multi-mode gateway controller 910 is saved on page-based basis, thereby enabling page-based switching between voice and visual modes. This means that if a user is browsing a page of content in a visual mode and the information delivery mode is switched to voice, the user will be able to instead listen to content from the same page. The converse operation is also supported by the multi-mode gateway controller 910; that is, it is possible to switch the information delivery mode from voice to visual with respect to a particular page being browsed. Example IV below illustrates the operation of the multi-mode gateway controller 910 in supporting the inventive page-based switching method in the context of a simple WML-based application incorporating a listen capability.

### EXAMPLE IV

```
  <?xml version=“1.0”?>
<!DOCTYPE wml PUBLIC “-//WAPFORUM//DTD WML 1.1//EN”
“http://www.wapforum.org/DTD/wml_1.1.xml”>
<wml>
  <head>
    <meta http-equiv=“Cache-Control” content=“must-revalidate”/>
    <meta http-equiv=“Expires” content=“Tue, 01 Jan 1980 1:00:00
    GMT”/>
    <meta http-equiv=“Cache-Control” content=“max-age=0”/>
  </head>
  <card title=“Press”>
    <p mode=“nowrap”>
      <do type=“accept” label=“OK”>
        <go href=“mail$(item:noesc).wml”/>
      </do>
      <big>Inbox</big>
      <select name=“item”>
        <option value=“1”>
          James Cooker Sub:Directions to my home
        </option>
        <option value=“2”>John Hatcher Sub:Directions </option>
      </select>
    </p>
  </card>
</wml>
```

When the source content of Example IV is accessed through the multi-mode gateway controller and its automatic multi-modal conversion feature is enabled, the following multi-modal content incorporating a <listen>tag is generated.

```
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
  <head>
    <meta http-equiv=“Cache-Control” content=“must-revalidate”/>
    <meta http-equiv=“Expires” content=“Tue, 01 Jan 1980 1:00:00
    GMT”/>
    <meta http-equiv=“Cache-Control” content=“max-age=0”/>
  </head>
  <template>
    <do type=“options” label=“Listen”>
      <go
      href=“http://MMGC_IPADDRESS/scripts/
      SwitchContextToVoice.Script?url=currentWML/>
    </do>
  </template>
  <card title=“Press”>
    <p mode=“nowrap”>
      <do type=“accept” label=“OK”>
        <go
        href=“http://MMGC_IPADDRESS/scripts/multimode.script?
        url=mail$(item:noesc).wml”/>
      </do>
      <big>Inbox</big>
      <select name=“item”>
        <option value=“1”>
          James Cooker Sub:Directions to my home
        </option>
        <option value=“2”>John Hatcher Sub:Directions </option>
      </select>
    </p>
  </card>
</wml>
```

As indicated by the above, the use of a <template>tag facilitates browsing in voice mode as well as in visual mode. Specifically, in the above example the <template>tag provides an additional option of “Listen”. Selection of this “Listen” soft key displayed by the subscriber unit 902 instructs the multi-mode gateway controller 910 to initiate a voice session and save the state of the current visual-based session. If the multi-mode gateway controller 910 were instead to employ the xHTML protocol, the analogous visual source would appear as follows:

```
<?xml version=“1.0”?>
  <!DOCTYPE html PUBLIC “-//WAPFORUM//DTD XHTML Mobile
  1.0//EN”
  “http://www.wapforum.org/DTD/xhtmlmobile10.dtd”>
  <html xmlns=“http://www.w3.org/1999/xhtml” >
    <head>
      <title>Email Inbox</title>
    </head>
  <body>
    <p>Inbox<br/>
    1. <a href=“mail1.xhtml” >James Cooker Sub: Directions to my
    home</a><br/>
    2. <a href=“mail2.xhtml” >John Hatcher Sub:Directions </a><br/>
    </p>
  </body>
</html>
```

When the above xHTML-based visual source is accessed via the multi-mode gateway controller 910, it is converted into xHTML-based multi-modal source through incorporation of one or more voice interfaces in the manner indicated below:

```
<?xml version=“1.0”?>
<!DOCTYPE html PUBLIC “-//WAPFORUM//DTD XHTML Mobile
1.0//EN”
“http://www.wapforum.org/DTD/xhtmlmobile10.dtd”>
<html xmlns=“http://www.w3.org/1999/xhtml” >
  <head>
    <title>Email Inbox</title>
  </head>
  <body>
    <p>Inbox<br/>
    <a
href=“http://MMGC_IPADDRESS/scripts/SwitchContextToVoice.Script?
url=currentxHTML”>Listen</a><br/>
    1. <a href=“mail1.xhtml” >James Cooker Sub: Directions to my
    home</a><br/>
    2. <a href=“mail2.xhtml” >John Hatcher Sub:Directions </a><br/>
    </p>
  </body>
</html>
```

In the above example the user may press a “listen” button of softkey displayed by the subscriber unit 902 at any point during visual browsing of the content appearing upon the subscriber unit 902. In response, the voice browser 950 will initiate content delivery in voice mode from the beginning of the page currently being visually browsed.

Link-Based Switching

During operation in the link-based switching mode, the switching of the mode of content delivery is not made applicable to the entire page of content currently being browsed. Instead, a selective switching of content delivery mode is performed. In particular, when link-based switching is employed, a user is provided with the opportunity to specify the specific page it is desired to browse upon the change in delivery mode becoming effective. For example, this feature is useful when it is desired to switch to voice mode upon selection of a menu item present in a WML page visually displayed by the subscriber unit 902, at which point the content associated with the link is delivered to the user in voice mode.

Example V below illustrates the operation of the multi-mode gateway controller 910 in supporting the link-based switching method of the present invention.

### EXAMPLE V

```
<?xml version=“1.0”?>
<!DOCTYPE wml PUBLIC “-//WAPFORUM//DTD
WML 1.1//EN”
“http://www.wapforum.org/DTD/wml_1.1.xml”>
<wml>
    <card title=“Press”>
        <p mode=“nowrap”>
            <do type=“accept” label=“OK”>
                <go href=“mail$(item:noesc).wml”/>
            </do>
            <do type=“options” label=“Listen”>
                <switch url=“mail$(item:noesc).wml”/>
            </do>
            <big>Inbox</big>
            <select name=“item”>
                <option value=“1”>
                    James Cooker Sub:Directions to my home
                </option>
                <option value=“2”>John Hatcher Sub:Directions
                </option>
            </select>
        </p>
    </card>
</wml>
```

The above example may be equivalently expressed using xHTML as follows:

```
<?xml version=“1.0”?>
<!DOCTYPE html PUBLIC “-//WAPFORUM//DTD XHTML
Mobile 1.0//EN”
“http://www.wapforum.org/DTD/xhtmlmobile10.dtd”>
<html xmlns=“http://www.w3.org/1999/xhtml” >
    <head>
        <title>Email Inbox</title>
    </head>
    <body>
        <p>Inbox<br/>
        <a href=“mail1.xhtml” >James Cooker Sub: Directions
        to my home</a><br/>
        <a
        href=“http://MMGC_IPADDRESS/scripts/
        SwitchContextToVoice.Script?url=
        mail1.xhtml”>Listen</a><br/>
        <a href=“mail2.xhtml” > John Hatcher Sub:Directions </a><br/>
        <a
        href=“http://MMGC_IPADDRESS/scripts/
        SwitchContextToVoice.Script?url=
        mail2.xhtml”>Listen</a><br/>
        </p>
    </body>
</html>
```

In the above example, once the user selects the “Listen” softkey displayed by the subscriber unit 902, the multi-mode gateway controller 910 disconnects the current data call and initiates a voice call using the voice browser 950. In response, the voice browser 950 fetches electronic mail information (i.e., mail*.wml) from the applicable remote content server and delivers it to the subscriber unit 902 in voice mode. Upon completion of voice-based delivery of the content associated with the link corresponding to the selected “Listen” softkey, a data connection is reestablished and the previous visual-based session resumed in accordance with the saved state information.

APPENDIX A

| | |
|---|---|
| /* | |
| * Function | : convert |
| * | |
| * Input | : filename, document base |
| * | |
| * Return | : None |
| * | |
| * Purpose | : parses the input wml file and converts it into vxml file. |
| * | |
| */ | |

```
    public void convert(String fileName,String base)
    {
      try {
      Document doc;
        Vector problems = new Vector( );
        documentBase = base;
      try {
            VXMLErrorHandler errorhandler =
            new VXMLErrorHandler(problems);
          DocumentBuilderFactory docBuilderFactory =
DocumentBuilderFactory.newInstance( );
          DocumentBuilder docBuilder =
docBuilderFactory.newDocumentBuilder( );
          doc = docBuilder.parse (new File (fileName));
            TraverseNode(doc);
            if (problems.size( ) > 0){
                Enumeration enum = problems.elements( );
                while(enum.hasMoreElements( ))
                    out.write((String)enum.nextElement( ));
            }
      } catch (SAXParseException err) {
          out.write (“** Parsing error“
            + ”, line “ + err.getLineNumber ( )
            + ”, uri ” + err.getSystemId ( ));
          out.write(“ ” + err.getMessage ( ));
      } catch (SAXException e) {
          Exception x = e.getException ( );
          ((x == null) ? e : x).printStackTrace ( );
      } catch (Throwable t) {
          t.printStackTrace ( );
      }
      } catch (Exception err) {
          err.printStackTrace ( );
        }
    }
```

### APPENDIX B

### EXEMPLARY WML TO VOICEXML CONVERSION

WML to VoiceXML Mapping Table

The following set of WML tags may be converted to VoiceXML tags of analogous function in accordance with Table B1 below.

TABLE B1

| WML Tag | VoiceXML Tag |
|---|---|
| Access | Access |
| Card | form |
| Head | Head |
| Meta | meta |
| Wml | Vxml |
| Br | Break |
| P | Block |
| Exit | Disconnect |
| A | Link |
| Go | Goto |
| Input | Field |
| Option | Choice |
| Select | Menu |

Mapping of Individual WML Elements to Blocks of VoiceXML Elements

In an exemplary embodiment a VoiceXML-based tag and any required ancillary grammar is directly substituted for the corresponding WML-based tag in accordance with Table A1. In cases where direct mapping from a WML-based tag to a VoiceXML tag would introduce inaccuracies into the conversion process, additional processing is required to accurately map the information from the WML-based tag into a VoiceXML-based grammatical structure comprised of multiple VoiceXML elements. For example, the following exemplary block of VoiceXML elements may be utilized to emulate the functionality of the to the WML-based Template tag in the voice domain.

```
WML-Based Template Element
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
<template>
      <do type=“options” label=“DONE”>
              <go href=“test.wml”/>
      </do>
  </template>
  <card>
                <p align=“left”>Test</p>
<select name=“newsitem”>
                <option onpick=“test1.wml”>Test1 </option>
          <option onpick=“test2.wml”>Test2</option>
            </select>
  </card>
</wml>
Corresponding Block of VoiceXML Elements
<?xml version=“1.0” ?>
<vxml version=“1.0”>
  <link next=“test.vxml”>
    <grammar>
      [
        (DONE)
      ]
    </grammar>
  </link>
  <menu>
    <prompt>Please say test1 or test2</prompt>
<choice next=“test1.vxml”> test1 </choice>
<choice next=“test2.vxml”> test2 </choice>
  </menu>
</vxml>
```

Example of Conversion of Actual WML Code to VoiceXML Code

```
Exemplary WML Code
<?xml version=“1.0”?>
<!DOCTYPE wml PUBLIC “-//WAPFORUM//DTD WML 1.1//EN”
“http://www.wapforum.org/DTD/wml_1.1.xml”>
<!-- Deck Source: “http://wap.cnet.com” -->
<!-- DISCLAIMER: This source was generated from parsed binary WML content. -->
<!-- This representation of the deck contents does not necessarily preserve -->
<!-- original whitespace or accurately decode any CDATA Section contents, -->
<!-- but otherwise is an accurate representation of the original deck contents -->
<!-- as determined from its WBXML encoding. If a precise representation is required, -->
<!-- then use the “Element Tree” or, if available, the “Original Source” view. -->
<wml>
  <head>
    <meta http-equiv=“Cache-Control” content=“must-revalidate”/>
    <meta http-equiv=“Expires” content=“Tue, 01 Jan 1980 1:00:00 GMT”/>
    <meta http-equiv=“Cache-Control” content=“max-age=0”/>
  </head>
  <card title=“Top Tech News”>
    <p align=“left”>
      CNET News.com
    </p>
    <p mode=“nowrap”>
        <select name=“categoryId” ivalue=“1”>
          <option onpick=“/wap/news/briefs/0,10870,0-1002-903-1-0,00.wml”>Latest News Briefs</option>
          <option onpick=“/wap/news/0,10716,0-1002-901,00.wml”>Latest News Headlines</option>
          <option onpick=“/wap/news/0,10716,0-1007-901,00.wml”>E-Business</option>
          <option onpick=“/wap/news/0,10716,0-1004-901,00.wml”>Communications</option>
          <option onpick=“/wap/news/0,10716,0-1005-901,00.wml”>Entertainment and Media</option>
          <option onpick=“/wap/news/0,10716,0-1006-901,00.wml”>Personal Technology</option>
          <option onpick=“/wap/news/0,10716,0-1003-901,00.wml”>Enterprise Computing</option>
      </select>
    </p>
  </card>
</wml>
Corresponding VoiceXML code
<?xml version=“1.0”?>
<vxml version=“1.0”>
<head> <meta/> <meta/> <meta/>
</head>
<form>
<block>
<prompt>CNET News.com</prompt>
</block>
<block>
<grammar>
[ ( latest news briefs ) ( latest news headlines ) ( e-business ) ( communications )
( entertainment and media ) ( personal technology ) ( enterprise computing ) ]
</grammar>
<goto next=“#categoryId” />
</block>
</form>
<menu id=“categoryId” >
<property name=“inputmodes” value=“dtmf” />
<prompt>Please Say <enumerate/>
</prompt>
<choice dtmf=“0” next=“http://server:port/Convert.jsp?url=
http://wap.cnet.com/wap/news/briefs/0,10870,0-1002-903-1-0,00.wml”> Latest News Briefs </choice>
<choice dtmf=“1” next=“http:// server:port /Convert.jsp?url=http://wap.cnet.com/wap/news/0,10716,0-
1002-901,00.wml”> Latest News Headlines </choice>
<choice dtmf=“2” next=“http:// server:port /Convert.jsp?url=http://wap.cnet.com/wap/news/0,10716,0-
1007-901,00.wml”> E-Business </choice>
<choice dtmf=“3” next=“http:// server:port /Convert.jsp?url=http://wap.cnet.com/wap/news/0,10716,0-
1004-901,00.wml”> Communications </choice>
<choice dtmf=“4” next=“http:// server:port/Convert.jsp?url= http://wap.cnet.com/wap/news/0,10716,0-
1005-901,00.wml”> Entertainment and Media </choice>
<choice dtmf=“5” next=“http:// server:port /Convert.jsp?url= http://wap.cnet.com/wap/news/0,10716,0-
1006-901,00.wml”> Personal Technology </choice>
<choice dtmf=“6” next=“http:// server:port /Convert.jsp?url= http://wap.cnet.com/wap/news/0,10716,0-
1003-901,00.wml”> Enterprise Computing </choice>
<default>
<reprompt/>
</default>
</menu>
</vxml>
<! END OF CONVERSION >
```

APPENDIX C
/*

| | |
|---|---|
| * Function | : TraverseNode |
| * | |
| * Input | : Node |
| * | |
| * Return | : None |
| * | |
| * Purpose | : Traverse's the Dom tree node by node and converts the |
| * | tag and attributes into equivalent vxml tags and attributes. |
| * | |
| */ | |

```
  void TraverseNode(Node el){
    StringBuffer buffer = new StringBuffer( );
    if (el == null)
      return;
    int type = el.getNodeType( );
    switch (type){
      case Node.ATTRIBUTE_NODE: {
          break;
        }
      case Node.CDATA_SECTION_NODE: {
          buffer.append(“<![CDATA[”);
          buffer.append(el.getNodeValue( ));
          buffer.append(“]]>”);
          writeBuffer(buffer);
          break;
        }
      case Node.DOCUMENT_FRAGMENT_NODE: {
          break;
        }
      case Node.DOCUMENT_NODE: {
          TraverseNode(((Document)el).getDocumentElement( ));
          break;
        }
      case Node.DOCUMENT_TYPE_NODE : {
          break;
        }
      case Node.COMMENT_NODE: {
          break;
        }
      case Node.ELEMENT_NODE: {
          if (el.getNodeName( ).equals(“select”)){
            processMenu(el);
          }else if (el.getNodeName( ).equals(“a”)){
            processA(el);
          } else {
          buffer.append(“<”);
          buffer.append(ConvertTag(el.getNodeName( )));
          NamedNodeMap nm = el.getAttributes( );
          if (first){
            buffer.append(“ version=\“1.0\””);
            first=false;
          }
          int len = (nm != null) ? nm.getLength( ) : 0;
          for (int j =0; j < len; j++){
            Attr attr = (Attr)nm.item(j);
buffer.append(ConvertAtr(el.getNodeName( ),attr.getNodeName( ),attr.getNodeValue( )));
          }
          NodeList nl = el.getChildNodes( );
          if ((nl == null) ||
              ((len = nl.getLength( )) < 1)){
            buffer.append(“/>”);
            writeBuffer(buffer);
          }else{
            buffer.append(“>”);
            writeBuffer(buffer);
            for (int j=0; j < len; j++)
              TraverseNode(nl.item(j));
            buffer.append(“</”);
            buffer.append(ConvertTag(el.getNodeName( )));
            buffer.append(“>”);
            writeBuffer(buffer);
          }
          }
          break;
        }
      case Node.ENTITY_REFERENCE_NODE : {
          NodeList nl = el.getChildNodes( );
          if (nl != null){
            int len = nl.getLength( );
            for (int j=0; j < len; j++)
              TraverseNode(nl.item(j));
          }
          break;
        }
      case Node.NOTATION_NODE: {
          break;
        }
      case Node.PROCESSING_INSTRUCTION_NODE: {
          buffer.append(“<?”);
          buffer.append(ConvertTag(el.getNodeName( )));
          String data = el.getNodeValue( );
          if ( data != null && data.length( ) > 0 ) {
            buffer.append(“ ”);
            buffer.append(data);
          }
          buffer.append(“ ?>”);
          writeBuffer(buffer);
          break;
        }
      case Node.TEXT_NODE: {
          if (!el.getNodeValue( ).trim( ).equals(“”)){
              try {
out.write(“<prompt>”+el.getNodeValue( ).trim( )+“</prompt>\n”);
              }catch (Exception e){
                e.printStackTrace( );
              }
            }
            break;
        }
    }
  }
/*
```

APPENDIX D

| | |
|---|---|
| /* | |
| * Function | : ConvertTag |
| * | |
| * Input | : wpa tag |
| * | |
| * Return | : equivalent vxml tag |
| * | |
| * Purpose | : converts a wml tag to vxml tag using the |
| | WMLTagResourceBundle. |
| * | |
| */ | |

```
    String ConvertTag(String wapelement){
        ResourceBundle rbd = new WMLTagResourceBundle( );
        try {
            return rbd.getString(wapelement);
        }catch (MissingResourceException e){
            return “ ”;
        }
    }
/*
```

| | |
|---|---|
| * Function | : ConvertAtr |
| * | |
| * Input | : wap tag, wap attribute, attribute value |
| * | |
| * Return | : equivalent vxml attribute with it's value. |
| * | |
| * Purpose | : converts the combination of tag+attribute of wml to a vxml |
| * | attribute using WMLAtrResourceBundle. |
| * | |
| */ | |

```
    String ConvertAtr(String wapelement,String wapattrib,String val){
        ResourceBundle rbd = new WMLAtrResourceBundle( );
        String tempStr=“ ”;
        String searchTag;
        searchTag =wapelement.trim( )+“-”+wapattrib.trim( );
        try {
          tempStr += “ ”;
            String convTag = rbd.getString(searchTag);
            tempStr += convTag;
            if (convTag.equalsIgnoreCase(“next”))
              tempStr += “=\”“+server+”?url=”+documentBase;
            else
              tempStr += “=\””;
          tempStr += val;
          tempStr += “\””;
            return tempStr;
        }catch (MissingResourceException e){
            return “ ”;
        }
    }
/*
```

| | |
|---|---|
| * Function | : processMenu |
| * | |
| * Input | : Node |
| * | |
| * Return | : None |
| * | |
| * Purpose | : process a menu node. it converts a select list into an |
| * | equivalent menu in vxml. |
| * | |
| */ | |

```
    private void processMenu(Node el){
        try {
        StringBuffer mnuString = new StringBuffer( );
        StringBuffer mnu = new StringBuffer( );
        String menuName =“NONAME”;
        int dtmfId = 0;
        StringBuffer mnuGrammar = new StringBuffer( );
        Vector menuItem = new Vector( );
        mnu.append(“<”+ConvertTag(el.getNodeName( )));
        NamedNodeMap nm = el.getAttributes( );
        int len = (nm != null) ? nm.getLength( ) : 0;
        for (int j =0; j < len; j++){
            Attr attr = (Attr)nm.item(j);
            if (attr.getNodeName( ).equals(“name”)){
                menuName=attr.getNodeValue( );
            }
            mnu.append(“ ” +
ConvertAtr(el.getNodeName( ),attr.getNodeName( ),
attr.getNodeValue( )));
        }
        mnu.append(“>\n”);
        mnu.append(“<property name=\“inputmodes\”
        value=\“dtmf\” />\n”);
        NodeList nl = el.getChildNodes( );
        len = nl.getLength( );
        for (int j=0; j < len; j++){
            Node el1 = nl.item(j);
            int type = el1.getNodeType( );
            switch (type){
                case Node.ELEMENT_NODE: {
                    mnuString.append(“<“+
                    ConvertTag(el1.getNodeName( )) +”
dtmf=\“ ” + dtmfId++ +“\” ”);
                    NamedNodeMap nm1 = el1.getAttributes( );
                    int len2 = (nm1 != null) ? nm1.getLength( ) : 0;
                    for (int l =0; l < len2; l++){
                        Attr attr1 = (Attr)nm1.item(l);
                        mnuString.append(“ ” +
ConvertAtr(el1.getNodeName( ),attr1.getNodeName( ),
attr1.getNodeValue( )));
                    }
                    mnuString.append(“>\n”);
                    NodeList nl1 = el1.getChildNodes( );
                    int len1 = nl1.getLength( );
                    for (int k=0; k < len1; k++){
                        Node el2 = nl1.item(k);
                        switch (el2.getNodeType( )){
                            case Node.TEXT_NODE: {
                                if (!el2.getNodeValue( ).trim( ).
                                equals(“ ”)){
mnuString.append(el2.getNodeValue( )+“\n”);
menuItem.addElement(el2.getNodeValue( ));
                                  }
                                }
                                break;
                        }
                    }
mnuString.append(“</”+ConvertTag(el1.getNodeName( ))+“>\n”);
                    break;
                }
            }
        }
        mnuString.append(“<default>\n<reprompt/>\n</default>\n”);
        mnuString.append(“</”+
        ConvertTag(el.getNodeName( ))+“>\n”);
        mnu.append(“<prompt>Please Say <enumerate/>”);
        mnu.append(“\n</prompt>”);
        mnu.append(“\n”+mnuString.toString( ));
        mnuGrammar.append(“<grammar>\n[ “);
        for(int i=0; i< menuItem.size( ); i++){
            mnuGrammar.append(“ ( ” +
            menuItem.elementAt(i) + “ ) ”);
        }
        mnuGrammar.append(”]\n</grammar>\n”);
        out.write(mnuGrammar.toString( ).toLowerCase( ));
        out.write(“\n<goto next=\“#” + menuName +“\”
/>\n</block>\n</form>\n”);
        out.write(mnu.toString( ));
        out.write(“<form>\n<block>\n”);
        }catch (Exception e){
            e.printStackTrace( );
        }
    }
/*
```

| | |
|---|---|
| * Function | : processA |
| * | |
| * Input | : link Node |
| * | |
| * Return | : None |
| * | |
| * Purpose | : converts an <A> i.e. link element into an equivalent for |
| * | vxml. |
| * | |
| */ | |

```
    private void processA(Node el){
        try {
        StringBuffer linkString = new StringBuffer( );
        StringBuffer link = new StringBuffer( );
        StringBuffer nextStr = new StringBuffer( );
        StringBuffer promptStr = new StringBuffer( );
        String fieldName = “NONAME”+field_id++;
        int dtmfId = 0;
        StringBuffer linkGrammar = new StringBuffer( );
        NamedNodeMap nm = el.getAttributes( );
        int len = (nm != null) ? nm.getLength( ) : 0;
        linkGrammar.append(“<grammar> [(next) (dtmf-1) (dtmf-2) ”);
        for (int j =0; j < len; j++){
            Attr attr = (Attr)nm.item(j);
            if (attr.getNodeName( ).equals(“href”)){
            nextStr.append(“<goto “
+ConvertAtr(el.getNodeName( ),attr.getNodeName( ),
attr.getNodeValue( )) +”/>\n”);
            }
        }
        linkString.append(“<field name=\“ ”+fieldName+“\”>\n”);
        NodeList nl = el.getChildNodes( );
        len = nl.getLength( );
        link.append(“<filled>\n”);
        for (int j=0; j < len; j++){
            Node el1 = nl.item(j);
            int type = el1.getNodeType( );
            switch (type){
                case Node.TEXT_NODE: {
                    if (!el1.getNodeValue( ).trim( ).
                    equals(“ ”)){
                        promptStr.append(“<prompt> Please Say
Next or“+el1.getNodeValue( )+”</prompt>”);
linkGrammar.append(“(“+el1.getNodeValue( ).toLowerCase( )+”)”);
                        link.append(“<if cond=\““+fieldName+” ==
‘“+el1.getNodeValue( )+”’ || “+fieldName+” ==‘dtmf-1’\”>\n”);
                        link.append(nextStr);
                        link.append(“<else/>\n”);
                        link.append(“<prompt>Next
                        Article</prompt>\n”);
                        link.append(“</if>\n”);
                    }
                }
                break;
            }
        }
        linkGrammar.append(“]</grammar>\n”);
        link.append(“</filled>\n”);
        linkString.append(linkGrammar);
        linkString.append(promptStr);
        linkString.append(link);
        linkString.append(“</field>\n”);
        out.write(“</block>\n”);
        out.write(linkString.toString( ));
        out.write(“<block>\n”);
        }catch (Exception e){
            e.printStackTrace( );
        }
    }
/*
```

| | |
|---|---|
| * Function | : writeBuffer |
| * | |
| * Input | : buffer String |
| * | |
| * Return | : None |
| * | |
| * Purpose | : print the buffer to PrintWriter. |
| * | |
| */ | |

```
    void writeBuffer(StringBuffer buffer){
        try {
            if (!buffer.toString( ).trim( ).equals(“ ”)){
                out.write(buffer.toString( ));
                out.write(“\n”);
            }
        }catch (Exception e){
            e.printStackTrace( );
        }
        buffer.delete(0,buffer.length( ));
    }
}
```

```
APPENDIX E
/*
* Method : readNode (Node)
*
*
*
* @Returns None
*
* The purpose of this method is to process a VoiceXML document containing <switch> tags.
* If a <switch> tag is encountered the <switch> tag is converted into a goto statement, which results in switching of
* voice mode to data mode using WAP push operations.
*
* If a <show> tag is encountered, the <show> tag is converted into a goto statement which result in switching of
*voice mode to data mode using SMS.
*
*/
public void readNode( Node nd, boolean checkSwitch ) throws MMVXMLException {
StringBuffer buffer = new StringBuffer( );
StringBuffer block =new StringBuffer( );
if( nd == null )
  return;
int type = nd.getNodeType( );
switch( type ){
  case Node.ATTRIBUTE_NODE:
    break;
  case Node.CDATA_SECTION_NODE:
    buffer.append(“<![CDATA[”);
    buffer.append(nd.getNodeValue( ));
    buffer.append(“]]>”);
    writeBuffer(buffer);
    break;
  case Node.COMMENT_NODE:
    break;
  case Node.DOCUMENT_FRAGMENT_NODE:
    break;
  case Node.DOCUMENT_NODE:
    try{
      DocumentType Dtp = doc.getDoctype( );
      if(Dtp != null ){
        String docType =“ ”;
        StringBuffer docVar = new StringBuffer( );
        if(Dtp.getName( ) != null) {
          if( (Dtp.getPublicId( ) != null ) &&
            Dtp.getSystemId( ) != null ){
            docType = “<!DOCTYPE “ + Dtp.getName( )+ ” PUBLIC \“ ”+
            Dtp.getPublicId( ) + “\”\“ ” + Dtp.getSystemId( )+“\”>”;
            docVar.append(docType);
          }else if(Dtp.getPublicId( ) != null ) {
          docType = “<!DOCTYPE “ + Dtp.getName( ) + ” PUBLIC \“ ” +
              Dtp.getPublicId( ) + “\”>”;
          docVar.append(docType);
          } else if(Dtp.getSystemId( ) != null ){
            docType = “<!DOCTYPE “ + Dtp.getName( ) +” SYSTEM \“ ”
            + Dtp.getSystemId( )+“\”>”;
            docVar.append(docType);
          }
        }
        if( !(docType.equals(“ ”)) ){
          writeBuffer( docVar);
        }
      }
    } catch( Exception ex ){
      throw new MMVXMLException(ex,Constants.PARSING_ERR);
    }
    readNode(((Document)nd).getDocumentElement( ),checkSwitch);
    break;
    case Node.DOCUMENT_TYPE_NODE:
      break;
    case Node.ELEMENT_NODE:
      String path1=“ ”;
      StringBuffer switch1 = new StringBuffer( );
      if( nd.getNodeName( ).equals( “switch” ) ){
        switchValue=true;
        processSwitch(nd);
      } else if( nd.getNodeName( ).equals( “show” ) ){
        showValue=true;
        processShow(nd);
      } else if( nd.getNodeName( ).equals( “disconnect” ) ){
        modifyDisconnect( );
      } else {
        if ( nd.getNodeName( ).equals(“form”)){
        addScriptFun( );
        addHangUpEvent( );
      }
      StringBuffer buf = new StringBuffer( );
      buffer.append(“<”);
      buffer.append( nd.getNodeName( ) );
      if(!(checkSwitch) ){
        if( nd.getNodeName( ).equals(“vxml”) ){
/**
* Adding link here, which throws event when user says “show”
* and Adding catch which will catch the event. Then sends that file
* for conversion, from VoiceXML to wml.
*
* @see sameDir( )
*/
      buf.append( “\n” );
      buf.append( “<link caching=\“safe\” next =\”” );
      String strServer = serverpath+ “?url=”;
      String strFile= strServer+
      currentURL+“&amp;phoneNo=”+phoneNo+“&amp;options=”+options;
      buf.append(strFile);
      buf.append( “\”>\n” );
      buf.append( “<grammar>\n” );
      buf.append( “[show]\n” );
      buf.append( “</grammar>\n” );
      buf.append( “</link>” );
      vxml = true;
    }
    if( nd.getNodeName( ).equals( “form”) || nd.getNodeName( ).equals( “menu” )) {
      if( count == 0 ){
        block.append( “<block>” );
        block.append( “Every time say show to view the page on your browser” );
        block.append( “</block>” );
        count++;
        form = true;
      }
    }
  }
  NamedNodeMap nmp = nd.getAttributes( );
  int length = (nmp != null) ? nmp.getLength( ) : 0;
  for( int j = 0; j < length; j++ ){
    Attr attr = ( Attr )nmp.item( j );
    String temp1 =“ ”;
    String tempStr1 =temp1 + attr.getNodeName( );
    if( attr.getNodeName( ).equals( “next” ) ){
      String temp2 = tempStr1 +“=\””;
      url = attr.getNodeValue( );
      String urlPath= convertUrl(url);
      String urlName = temp2+urlPath ;
      buffer.append(urlName);
    } else if ( nd.getNodeName( ).equals( “goto”) && attr.getNodeName( ).equals( “expr” )){
      String temp2 = tempStr1 +“=\””;
      String tempStr2 = temp2 +“convertLink(“+attr.getNodeValue( )+”)\””;
      buffer.append( tempStr2 );
    } else {
      String temp2 = tempStr1 +“=\””;
      String tempStr2 = temp2 +attr.getNodeValue( )+“\””;
      buffer.append( tempStr2 );
    }
  }
  NodeList nl = nd.getChildNodes( );
  int length1=nl.getLength( );
    if (( nl == null) || (( length1 = nl.getLength( ) ) < 1)){
      buffer.append( “/>” );
    } else {
    if(!(checkSwitch)) {
      if( vxml ){
        vxml = false;
        buffer.append( “>” );
        writeBuffer( buffer );
        writeBuffer( buf );
      } else if( form ){
        buffer.append( “>” );
        writeBuffer( buffer );
        writeBuffer( block );
      } else {
        buffer.append( “>” );
      }
    } else {
      buffer.append( “>” );
    }
    writeBuffer( buffer );
    for( int j = 0; j < length1; j++ )
      readNode( nl.item( j ),checkSwitch );
    buffer.append( “</” );
    buffer.append( nd.getNodeName( ) );
    buffer.append( “>” );
  }
}
writeBuffer( buffer );
break;
case Node.ENTITY_NODE:
  break;
case Node.ENTITY_REFERENCE_NODE:
  break;
case Node.NOTATION_NODE:
  break;
case Node.PROCESSING_INSTRUCTION_NODE:
  break;
case Node.TEXT_NODE:
  if ( !nd.getNodeValue( ).trim( ).equals(“ ”) ){
    buffer.append( nd.getNodeValue( ) );
    writeBuffer( buffer );
  }
  break;
default:
  break;
}
}
/*
* Method : processSwitch (Node)
*
*
*
* @Returns None
*
* The purpose of this method is to process a <switch> tag incorporated within a VoiceXML document.
*In general, this method replaces the <switch> tag with a goto tag in order to effect the desired switching
*from voice mode to data mode using the WAP push operation.
*
*
*
*/
  public void processSwitch( Node n ) throws MMVXMLException {
    StringBuffer buf1 =new StringBuffer( );
    StringBuffer buf = new StringBuffer( );
    String path1 =“ ”;
    String urlPath=“ ”;
    String urlStr2=“ ”;
    int index=0;
    boolean subject = true;
    String title=“ ”;
    buf.append( “<” );
    String menuName =“ ”;
    buf.append(“goto next = \””);
    NamedNodeMap nm = n.getAttributes( );
    int len = ( nm != null ) ? nm.getLength( ) : 0;
    for( int j = 0; j < len; j++ ){
      Attr attr = ( Attr )nm.item( j );
      String temp1 =“ ”;
      if(attr.getNodeName( ).equals(“title”)){
        title =“&amp;title=”+attr.getNodeValue( );
        subject=false;
      }
      if( attr.getNodeName( ).equals( “url” ) ){
        /** There is a check for “url” does it start with “#”, “http”,
        * “/” or “./”. changes it to appropriate “URLs”.
        */
        urlStr2 = attr.getNodeValue( );
      }
    }
    if( (subject)) {
      title = “&amp;title=”+“New Alert” ;
    }
    urlPath =convertUrl(urlStr2+title);
    String finalUrl = urlPath;
    buf.append(finalUrl);
    NodeList nl = n.getChildNodes( );
    len = nl.getLength( );
    if (( nl == null) || (( len = nl.getLength( ) ) < 1 ) ){
      buf.append( “/>\n” );
    }else{
      buf.append( “>” );
    }
    writeBuffer( buf );
  }
/*
* Method : processShow (Node)
*
*
*
* @Returns None
*
* The purpose of this method is to process the <switch> tag inside VoiceXML documents.
* The method replaces the <switch> tag with a goto tag, which results in the switching
* from voice mode to data mode using SMS. Alternatively, both the voice and data channels may be open
* simultaneously as specified by the developer in the show tag.
*
*
*/
public void processShow( Node n ) throws MMVXMLException {
    StringBuffer buf1 =new StringBuffer( );
    StringBuffer buf = new StringBuffer( );
    String urlPath =“ ”;
    String urlStr2=“ ”;
    String path1 =“ ”;
    boolean textb = false;
    boolean next =false;
    boolean show =true;
    buf.append( “<” );
    String menuName =“ ”;
    int index=0;
    String text=“ ”;
    buf.append(“goto next = \””);
    NamedNodeMap nm = n.getAttributes( );
    int len = ( nm != null ) ? nm.getLength( ) : 0;
    for( int j = 0; j < len; j++ ){
      Attr attr = ( Attr )nm.item( j );
      String temp1 =“ ”;
      if(attr.getNodeName( ).equals(“text”)){
        text =“SMSTxt=”+attr.getNodeValue( );
        textb = true;
      }
      if( attr.getNodeName( ).equals( “next” ) ){
        next = true;
        String tempStr2=“ ”;
        /** There is a check for “url” does it start with “#” , “http”,
        * “/” or “./”. changes it to appropriate “URLs”.
        */
        urlStr2 = attr.getNodeValue( );
      }
    }
    if (textb == true && next == true){
      urlPath=convertUrl(urlStr2+“&amp;”+text);
    } else if (next == true){
      urlPath =convertUrl(urlStr2);
    }
    buf.append(urlPath);
    NodeList nl = n.getChildNodes( );
    len = nl.getLength( );
    if (( nl == null ) || (( len = nl.getLength( ) ) < 1 ) ){
      buf.append( “/>\n” );
    } else {
      buf.append( “>” );
    }
    writeBuffer( buf );
  }
```

```
APPENDIX F
/*
* Method : TraverseNode (Node)
*
*
*
* @Returns None
*
* The purpose of this method is to process a WML-based document.
* If there is no attribute attached with <wml> e.g. multimode=false, Listen button is added.
* If there is an attribute attached with <wml> e.g. multimode=false no Listen button is added to the document.
* If there is an attribute attached with <wml> e.g. multimode=false and there is a <switch> tag, the <switch> tag
* tag is converted into a Listen button .
*
*
*/
public void TraverseNode(Node n) throws MMHWMLException{
  StringBuffer buffer = new StringBuffer( );
  if (n == null)
    return;
  int type = n.getNodeType( );
  switch (type){
  case Node.ATTRIBUTE_NODE: {
    break;
    }
  case Node.CDATA_SECTION_NODE: {
    buffer.append(n.getNodeValue( ));
    writeBuffer(buffer);
    break;
    }
  case Node.DOCUMENT_FRAGMENT_NODE: {
    break;
    }
  case Node.DOCUMENT_NODE: {
    TraverseNode(((Document)n).getDocumentElement( ));
    break;
    }
  case Node.DOCUMENT_TYPE_NODE : {
    break;
    }
  case Node.COMMENT_NODE: {
    break;
  }
  case Node.ELEMENT_NODE: {
    String val=n.getNodeName( );
    if(val.equals(“img”)){
      buffer.append(processImage(n));
      writeBuffer(buffer);
    } else if(val.equals(“switch”)){
      buffer.append(processSwitch(n));
      writeBuffer(buffer);
    } else {
      if(val.equals(“card”)){
        if( multimode ){
          if(check==false && switchTag == false){
            buffer.append(“<template>”);
            buffer.append(“\n”);
            buffer.append(“<do type=\“listen\”
            label=\“ ”+listentag+“\”>\n”);
            buffer.append(“<go
href=\“ ”+listen+“?”+“cId=”+callerId+“&”+convertUrl(currentUrlGiven)+“\” />\n”);
            buffer.append(“</do>\n”);
            buffer.append(“</template>\n”);
            check=true;
          }
        }
        // buffer.append(“<card ”);
      }
      if(val.equals(“wml”) ){
        buffer.append(“<”);
        buffer.append(val);
        endWml=true;
      } else {
        buffer.append(“<”);
        buffer.append(val);
        buffer.append(“ ”);
      }
      NamedNodeMap nm = n.getAttributes( );
      int len=nm.getLength( );
      if((nm!=null)||len!=0){
        for (int j =0; j < len; j++){
          Attr attr = (Attr)nm.item(j);
          String val1=attr.getNodeName( );
          String val2=attr.getNodeValue( );
          if(val1.equalsIgnoreCase(“multimode”) ){
            continue;
          }
          buffer.append(“ ”);
          buffer.append(val1);
          buffer.append(“=\””);
          buffer.append(convertAtr(val1,val2));
          buffer.append(“\””);
        }
        writeBuffer(buffer);
      }
      if(n.getNodeName( ).equals(“template”)){
        if(afterwmltag){
          if (multimode){
            buffer.append(“>\n”);
            buffer.append(“<do type=\“listen\” label=\“ ”+listentag+“\”>\n
”);
            buffer.append(“<go
href=\“ ”+listen+“?”+“cId=”+callerId+“&”+convertUrl(currentUrlGiven) +“\” />\n”);
            buffer.append(“</do”);
          }
          afterwmltag=false;
          check=true;
        }
      }
      NodeList list = n.getChildNodes( );
      len=list.getLength( );
      if((list == null) || (len ==0)){
        buffer.append(“/>\n”);
        writeBuffer(buffer);
      } else {
        buffer.append(“>\n”);
        writeBuffer(buffer);
        for (int j=0; j < len; j++)
          TraverseNode(list.item(j));
        buffer.append(“</”);
        buffer.append(n.getNodeName( ));
        buffer.append(“>\n”);
        writeBuffer(buffer);
      }
    }
    break;
  }
  case Node.ENTITY_REFERENCE_NODE : {
    NodeList list = n.getChildNodes( );
    if (list != null){
      int len = list.getLength( );
      for (int j=0; j < len; j++)
        TraverseNode(list.item(j));
    }
    break;
    }
  case Node.NOTATION_NODE: {
    break;
    }
  case Node.PROCESSING_INSTRUCTION_NODE: {
    String data1=n.getNodeName( );
    String data = n.getNodeValue( );
    if (data != null && data.length( ) > 0) {
      buffer.append(“ ”);buffer.append(data1);
      buffer.append(data);
    }
    buffer.append(“ ?>\n”);
    writeBuffer(buffer);
    break;
    }
    case Node.TEXT_NODE: {
      if (!n.getNodeValue( ).trim( ).equals(“ ”)){
        try {
          buffer.append(replaceOtherEntityRef(n.getNodeValue( )));
          buffer.append(“\n”);
          responseBuffer.append(buffer.toString( ));
          buffer.delete(0,buffer.length( ));
        }catch (Exception e){
          throw new MMHWMLException(e);
        }
      }
      break;
    }
  }
  }
/*
* Method : processSwitch (Node)
*
*
*
* @Returns String
*
* The purpose of this method is to process a <switch> tag within a WML-based document.
* The method replaces the <switch> tag with a listen button.
*
*
*
*/
public String processSwitch(Node nd) throws MMHWMLException {
  String urlStr=“ ”;
  if (nd == null)
    return “ ”;
  NamedNodeMap nm = nd.getAttributes( );
  int len=nm.getLength( );
  if(len==0){
    urlStr = currentUrlGiven;
  }
  for (int j =0; j < len; j++){
    Attr attr = (Attr)nm.item(j);
    if (attr.getNodeName( ).equals(“url”)){
      urlStr=attr.getNodeValue( );
    }
  }
  if(urlStr.equals(“ ”) ){
    return “ ”;
  } else if(urlStr.equals(“currentUrlGiven”)){
    return “go href=\“ ”+listen+“?cId=”+callerId+“&url=”+currentUrlGiven+“\”/>\n”;
  } else {
    return “<go href=\“ ”+listen+“?cId=”+callerId+“&”+convertUrl(urlStr)+“\” />\n”;
  }
}
```

```
APPENDIX G
/*
* Method : TraverseNode (Node)
*
*
*
* @Returns None
*
* The purpose of this method is to process an xHTML document.
* If there is no attribute attached with <html> tag e.g. multimode=false, Listen button is added to the document.
* If there is an attribute attached with <html> tag e.g. multimode=false no Listen button is added to the document.
* If there is an attribute attached with <html> tag e.g. multimode=false and there is a <switch> tag, the <switch> tag
* is converted into a Listen button .
*
*
*/
  /*
* Function is TraverseNode
*
* Input is Node
*
* @Returns None
*
* Purpose is to traverse the DOM tree on a node-by-node basis and convert xHTML to
* hybrid xHTML
*
*/
public void TraverseNode(Node n)
    throws hXhtmlException {
  if (n == null)
      return;
  int type = n.getNodeType( );
  switch (type) {
  case Node.ATTRIBUTE_NODE: {
      break;
      }
  case Node.CDATA_SECTION_NODE: {
      buffer.append(“<![CDATA[”);
      buffer.append(n.getNodeValue( ));
      buffer.append(“]]>”);
      break;
      }
  case Node.DOCUMENT_FRAGMENT_NODE: {
      break;
      }
  case Node.DOCUMENT_NODE: {
      TraverseNode(((Document)n).getDocumentElement( ));
      break;
            }
  case Node.DOCUMENT_TYPE_NODE: {
      break;
      }
  case Node.COMMENT_NODE: {
      break;
      }
  case Node.ELEMENT_NODE: {
      String eventId = “NULL”;
      String val = n.getNodeName( );
      buffer.append(“<”);
      buffer.append(val);
      buffer.append(“ ”);
      NodeList list = n.getChildNodes( );
      len = list.getLength( );
      if((list==null) || (len==0)) {
        buffer.append(“/>\n”);
      } else if(val.equals(“swicth”)) {
        buffer.append(processSwitch( ));
      } else {
        buffer.append(“>\n”);
        if (n.getNodeName( ).equals(“html”)){
          if( multimode ){
            if(switchTag == false){
              buffer.append(“<a ”);
              buffer.append(“href=\“ ”+listen+“?”+convertUrl(currentUrlGiven) +
            “&cId=”+callerId+ “\”“ + ” >\n”);
              buffer.append(“listen”);
              buffer.append(“</a>\n”);
            }
          }
        }
        for (int j=0;j<len;j++)
          TraverseNode(list.item(j));
          buffer.append(“</”);
          buffer.append(n.getNodeName( ));
          buffer.append(“>\n”);
        }
        break;
      }
  case Node.ENTITY_REFERENCE_NODE: {
      NodeList list = n.getChildNodes( );
      if (list != null) {
        int len = list.getLength( );
        for (int j=0; j< len; j++)
          TraverseNode(list.item(j));
      }
      break;
      }
  case Node.NOTATION_NODE: {
      break;
      }
  case Node.PROCESSING_INSTRUCTION_NODE: {
      String nodeName = n.getNodeName( );
      String nodeValue = n.getNodeValue( );
      if ((nodeValue != null) && (nodeValue.length( ) >0)) {
        buffer.append(“ ”);
        buffer.append(nodeName);
        buffer.append(nodeValue);
      }
      buffer.append(“ ?>\n”);
      break;
      }
  case Node.TEXT_NODE: {
      if ((!n.getNodeValue( ).trim( ).equals(“ ”))){
        try {
          buffer.append(replaceOtherEntityRef(n.getNodeValue( )));
          buffer.append(“\n”);
        } catch (Exception e) {
          throw new hXhtmlException(e);
        }
        break;
      }
      }
  }
}
/*
* Method : processSwitch (Node)
*
*
*
* @Returns String
*
* The purpose of this method is to process a <switch> tag within an xHTML document.
* The method replaces the <switch> tag with a listen button.
*
*
*
*/
public String processSwitch(Node nd) throws MMHWMLException {
  String urlStr=“ ”;
  StringBuffer tmpBuffer = new StringBuffer( );
  if (nd == null)
      return “ ”;
      NamedNodeMap nm = nd.getAttributes( );
      int len=nm.getLength( );
      if(len==0){
        urlStr = currentUrlGiven;
      }
      for (int j =0; j < len; j++){
        Attr attr = (Attr)nm.item(j);
        if (attr.getNodeName( ).equals(“url”)){
          urlStr=attr.getNodeValue( );
        }
      }
      if (urlStr.equals(“ ”) ){
        return “ ”;
      } else {
      tmpBuffer.append(“<a ”);
      tmpBuffer.append(“href=\“ ”+listen+“?”+convertUrl(currentUrlGiven) +
“&cId=”+callerId+ “\”“ + ” >\n”);
      tmpBuffer.append(“listen”);
      tmpBuffer.append(“</a>\n”);
      return tmpBuffer.toString( );
  }
}
```

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

What is claimed is:

1. A method for browsing a network comprising:
receiving a first user request at a voice browser, said voice browser operating in accordance with a voice-based protocol;
generating a browsing request in response to said first user request, said browsing request identifying information available within said network;
creating multi-modal content on the basis of said information, said multi-modal content being formatted in compliance with said voice-based protocol and incorporating a reference to visual-based content formatted in accordance with a visual-based protocol; and
providing said multi-modal content to said voice browser.

2. The method of claim 1 further including receiving a switch instruction associated with said reference and, in response, switching a context of user interaction from voice to visual and retrieving said visual-based content from within said network.

3. The method of claim 2 wherein said switching is performed by a switching server, said switching server utilizing a messaging server in delivering said visual-based content to an end user device.

4. The method of claim 3 further including rendering said multi-modal content based upon a protocol compatible with a rendering capability of said end user device.

5. The method of claim 4 wherein said protocol is selected from the group consisting of: push protocol, SMS protocol, any visual-based protocol.

6. The method of claim 1 further including receiving a show instruction associated with said reference and, in response, establishing a visual session with an end user device.

7. The method of claim 6 further including also establishing a voice session with said end user device.

8. The method of claim 7 further including engaging in dual channel operation with said end user device through said voice session and said visual session, said dual channel operation including sending an SMS message to said end user device during said voice session.

9. The method of claim 7 further including engaging in dual channel operation with said end user device through said voice session and said visual session, said dual channel operation including sending a visual alert to said end user device via a WAP gateway during said voice session.

10. The method of claim 7 further including engaging in dual channel operation with said end user device through said voice session and said visual session, said dual channel operation including sending a visual alert to said end user device via a visual gateway during said voice session.

11. The method of claim 7 further including coordinating simultaneous operation of said voice session and said visual session.

12. The method of claim 2 further including creating additional multi-modal content on the basis of said visual-based web content, said additional multi-modal content incorporating a reference to voice-based content within said network.

13. The method of claim 2 further including:
establishing a voice-based connection over said communication link, said voice-based connection carrying said first user request from a first user device, terminating, in response to receipt of said switch instruction, said voice-based connection, and communicating said visual-based content to said first user device.

14. The method of claim 12 further including:
establishing a voice-based connection over said communication link, said voice-based connection carrying said first user request from a first user device, terminating, in response to receipt of said switch instruction, said voice-based connection, and communicating said additional multi-modal content to said first user device.

15. A method for browsing a network comprising:
receiving a first user request at a gateway unit, said gateway unit operating in accordance with a visual-based protocol;
generating a browsing request in response to said first user request, said browsing request identifying information available within said network;
creating multi-modal content on the basis of said information, said multi-modal content being formatted in compliance with said visual-based protocol and incorporating a reference to voice-based content formatted in accordance with a voice-based protocol; and
providing said multi-modal content to said gateway unit.

16. The method of claim 15 further including receiving a switch instruction associated with said reference and, in response, switching a context of user interaction from visual to voice and retrieving said voice-based content from within said network.

17. The method of claim 15 further including receiving a voice instruction associated with said reference and, in response, initiating a voice session without interrupting a current visual session.

18. The method of claim 15 further including receiving a voice instruction associated with said reference and, in response, sending a voice instruction without interrupting a current voice and visual sessions.

19. The method of claim 17 further including concurrently coordinating between the voice and visual sessions.

20. The method of claim 16 further including creating additional multi-modal content on the basis of said voice-based content, said additional multi-modal content incorporating a reference to visual-based content available within said network.

21. The method of claim 16 further including:
establishing a visual-based connection over said communication link, said visual-based connection carrying said first user request from a first user device, terminating, in response to receipt of said switch instruction, said visual-based connection, and communicating said voice-based content to said first user device.

22. The method of claim 20 further including:
establishing a visual-based connection over said communication link, said visual-based connection carrying said first user request from a first user device, terminating, in response to receipt of said switch instruction, said visual-based connection, and communicating said voice-based multi-modal content to said first user device.

23. A system for browsing a network comprising:
a voice browser operating in accordance with a voice-based protocol, said voice browser receiving a first user request and generating a first browsing request in response to said first user request;
a visual-based gateway operating in accordance with a visual-based protocol, said visual-based gateway receiving a second user request and generating a second browsing request in response to said first user request; and
a multi-mode gateway controller in communication with said voice browser and said visual-based gateway, said multi-mode gateway controller including a voice-based multi-modal converter for generating voice-based multi-modal content in response to said first browsing request.

24. The system of claim 23 wherein said multi-mode gateway controller further includes a visual-based multi-modal converter for generating visual-based multi-modal content in response to said second browsing request.

25. The system of claim 24 wherein said multi-mode gateway controller includes a switching module for switching a context of user interaction from voice to visual and invoking said visual-based multi-modal converter in response to a switch instruction received from said voice browser.

26. The system of claim 22 wherein said multi-mode gateway controller includes a switching module for switching a context of user interaction from visual to voice and invoking said voice-based multi-modal converter in response to a switch instruction received from said visual-based gateway.

27. The system of claim 24 wherein said switching module terminates, in response to said switch instruction, a voice connection through said voice browser to a first user device and initiates establishment of a data connection to said first user device for transporting said visual-based multi-modal content.

28. The system of claim 26 wherein said switching module terminates, in response to said switch instruction, a data connection through said visual-based gateway to a first user device and initiates establishment of a voice-based connection to said first user device for transporting said voice-based multi-modal content.

29. A system for browsing a network comprising:
a voice browser operating in accordance with a voice-based protocol, said voice browser receiving a first user request and generating a first browsing request in response to said first user request;
a visual-based gateway operating in accordance with a visual-based protocol, said visual-based gateway receiving a second user request and generating a second browsing request in response to said second user request; a multi-mode gateway controller in communication with said voice browser and said visual-based gateway, said multi-mode gateway controller including a visual-based multi-modal converter for generating visual-based multi-modal content in response to said second browsing request.

30. The system of claim 29 wherein said multi-mode gateway controller further includes a voice-based multi-modal converter for generating voice-based multi-modal content in response to said first browsing request.

31. A multi-mode gateway controller for facilitating browsing of a network, said gateway controller comprising:
a first port for receiving a first browsing request over a voice-based connection established through said first port, said first browsing request identifying information available within said network;
a voice-based multi-modal converter for creating voice-based multi-modal content on the basis of said information, said voice-based multi-modal content being formatted in compliance with a voice-based protocol and incorporating a reference to a location within said network storing visual-based content formatted in accordance with a visual-based protocol; and
a switching module for retrieving said visual-based content upon receipt of a switch instruction over said voice-based connection.

32. The multi-mode gateway controller of claim 31 further including:
a second port for receiving a second browsing request identifying additional information available within said network; and
a visual-based multi-modal converter for creating visual-based multi-modal content on the basis of said additional information, said visual-based multi-modal content being formatted in compliance with said visual-based protocol and incorporating a reference to a location within said network storing voice-based content formatted in accordance with a voice-based protocol.

33. The multi-mode gateway controller of claim 31 wherein said switching module, in response to said receipt of said switch instruction, terminates said voice-based connection and establishes a data connection through a second port of said multi-mode gateway controller wherein said visual-based content is transported over said data connection.

34. A multi-mode gateway controller for facilitating browsing of a network, said gateway controller comprising:
a first port for receiving a first browsing request over a visual-based connection established through said first port, said first browsing request identifying information available within said network;
a visual-based multi-modal converter for creating visual-based multi-modal content on the basis of said information, said visual-based multi-modal content being formatted in compliance with a visual-based protocol and incorporating a reference to a location within said network storing voice-based content formatted in accordance with a voice-based protocol; and
a switching module for retrieving said voice-based content upon receipt of a switch instruction over said visual-based connection.

35. The multi-mode gateway controller of claim 34 further including:
a second port for receiving a second browsing request identifying additional information available within said network; and
a voice-based multi-modal converter for creating voice-based multi-modal content on the basis of said additional information, said voice-based multi-modal content being formatted in compliance with said voice-based protocol and incorporating a reference to a location within said network storing visual-based content formatted in accordance with a visual-based protocol.

36. The multi-mode gateway controller of claim 33 wherein said switching module, in response to said receipt of said switch instruction, terminates said visual-based connection and establishes a voice-based connection through a second port of said multi-mode gateway controller wherein said voice-based content is transported over said voice-based connection.

37. A method for multi-modal information delivery comprising:
receiving a first user request at a browser module, said browser module operating in accordance with a first protocol applicable to a first mode of information delivery;
generating a browsing request in response to said first user request, said browsing request identifying information available within a network;
creating multi-modal content on the basis of said information, said multi-modal content being formatted in compliance with said first protocol and incorporating a reference to content formatted in accordance with a second protocol applicable to a second mode of information delivery; and
providing said multi-modal content to said browser module.

38. The method of claim 37 further including receiving a switch instruction associated with said reference and, in response, (i) switching a context of user interaction from being compliant with said first protocol to being compliant with said second protocol, and (ii) retrieving said content from within said network.
